(19) United States
(12) Patent Application Publication
(10) Pub. No.: US 2022/0024742 A1
(43) Pub. Date: Jan. 27, 2022

(54) HAND-HELD CUTTING TOOLS FOR OPENING BLISTERS OF BLISTER PILL PACKS

(71) Applicants: Arjet Skenduli, San Jose, CA (US); Roy P. Pereira, Newark, CA (US)

(72) Inventors: Arjet Skenduli, San Jose, CA (US); Roy P. Pereira, Newark, CA (US)

(21) Appl. No.: 17/174,341

(22) Filed: Feb. 11, 2021

Related U.S. Application Data
(60) Provisional application No. 63/056,583, filed on Jul. 25, 2020.

(51) Int. Cl. B67B 7/46; B26B 27/00; B65B 69/00

(52) U.S. Cl. CPC B67B 7/30; B65B 69/0058; B26B 27/005

(57) ABSTRACT

Hand-held cutting tool are provided that open blisters of a blister pill pack. The hand-held cutting tools includes a handle, an anvil, and a blade. The handle includes two arms having proximal and distal ends, and a connecting portion extending from the proximal ends of the arms. The connecting portion maintains spatial separation between the proximal ends of the arms. The anvil and blade extend from respective distal ends of the arms. The blade includes a cutting edge facing the anvil. The arms are configured to move between an open state and a closed state. When the arms are moved from the open state with the blister positioned between the anvil and the cutting edge to the closed state, the cutting edge is configured to puncture and cut the blister open to enable user access to pills inside the blister.

### CROSS-REFERENCE TO RELATED APPLICATIONS

This application claims benefit under 35 U.S.C. § 119(e) of U.S. Provisional Application No. 63/056,583, filed Jul. 25, 2020, the entirety of which is incorporated herein by reference.

### FIELD

The present disclosure relates generally to the field of blister pill packs, and more particularly to cutting tools that are used to open blisters of blister pill packs.

### BACKGROUND

Blister pill packs (or packages) are commonly used to store pills of medicine or supplements. For example, pharmaceutical companies may use blister pill packs to package a number of over-the-counter (OTC) or prescription pills, as an alternative to bottling pills. Similarly, supplement companies may use blister pill packs to package vitamins or other supplements.

Generally, a blister pill pack includes a tray usually formed from a single thermoformed plastic and having multiple cavity-forming protrusions (or pockets). Typically, one or two pills are placed in the cavities of the protrusions and a backing layer applied to the tray to seal the pills within the cavities of the protrusions. The backing layer may include, for example, paperboard, lidding seal of aluminum foil, plastic, or combination thereof. The backing layer is configured to be penetrable (e.g., a penetrable lidding seal, perforated, etc.) where the backing layer covers the cavities. Each sealed cavity of a protrusion may typically contain one or two pills inside. A blister pill pack typically includes multiple blisters positioned in a series of rows and columns.

Usually, a blister is opened by a person using a finger to press down on the plastic protrusion to force the pill through the penetrable backing layer on the back of the blister, or alternatively, by using their finger or fingernail to penetrate the backing layer on the back of the blister and to scoop the pill out. While the back of the blister is intended to be penetrable, it is also designed to be durable enough to remain sealed and avoid any accidental opening during handling or storage. The amount of force needed to penetrate the backing layer can vary among blister pill packs, with some requiring a surprisingly significant amount of force. This can make opening the blister somewhat cumbersome. Some people may have difficulty using their hands to remove a pill from a blister, especially those requiring significant force. For example, certain people may lack sufficient finger strength to press the pill through the backing layer, or experience pain or discomfort when trying to do so. Furthermore, the backing layer on the back of the blister may be quite strong, making it difficult for some users to penetrate with their fingers. The plastic protrusion may also be particularly thick or stiff, making it difficult to sufficiently press the pill through the backing layer. Some existing tools have been made to assist users with opening a blister of a blister pill pack. However, the existing tools come with their own set of issues and problems, such as being bulky, cumbersome, hard to hold with one hand, complicated to use, difficult to use without obstructing the user's view, difficult to fit between rows and columns of blisters, etc.

### SUMMARY

In an aspect of the present disclosure, a hand-held cutting tool is provided that opens a blister of a blister pill pack to enable user access to one or more pills inside the blister. The hand-held cutting tool includes: a handle, an anvil, and a blade. The handle includes: a first arm having a first proximal end and a first distal end, a second arm having a second proximal end and a second distal end; and a connecting portion extending from the first and second proximal ends of the respective first and second arms. The first and second arms extend from the connecting portion to the respective first and second distal ends. The connecting portion is configured to maintain spatial separation between the first and second proximal ends. The anvil extends from the first distal end of the first arm. The blade extends from the second distal end of the second arm. The blade includes a cutting edge facing the anvil. The first and second arms are configured to move between a closed state and an open state. The closed state includes: the first and second distal ends moved all the way towards each other; and the cutting edge facing, and adjacent to, the anvil. The open state includes: the first and second distal ends moved out of the closed state; and the cutting edge facing, and spatially separated from, the anvil. When the first and second arms are moved from the open state with the blister positioned between the anvil and the cutting edge to the closed state, the cutting edge is configured to puncture and cut the blister open to enable user access to one or more pills inside the blister.

In an embodiment, the cutting edge includes an edge point configured to puncture the blister when the first and second arms are moved from the open state with the blister positioned between the anvil and the cutting edge to the closed state.

In an embodiment, the blade further includes: a first base side that is flat, and a beveled side opposite the first base side. The bevel side includes a bevel that angles down to the first base side to form the cutting edge. In an embodiment, the anvil includes a second base side that is flat. The first base side of the blade is flush with the second base side of the anvil when the first and second arms are in the closed state. When the first and second arms are moved from the open state with the blister positioned between the anvil and the cutting edge, the first base side of the blade and the second base side of the anvil are configured to be placed flat against a flat base of the blister pill package. When the first and second arms are moved from the open state with the blister positioned between the anvil and the cutting edge to the closed state, the cutting edge is configured to puncture and cut the blister open in a base region of the blister such that the cutting edge is advanced between the one or more pills and the flat base. The blister extends from the flat base of the blister pill pack and the base region is next to the flat base.

In an embodiment, the anvil includes a first surface facing the cutting edge. The first surface is curved and has a concavity facing the cutting edge of the blade. When the first and second arms are in the closed state, an entire length of the cutting edge is adjacent to the anvil such that the cutting edge is shielded by the anvil.

In an embodiment, the anvil further includes a stop element extending toward the second arm. The stop element is configured to abut and stop the blister when the blister is inserted between the anvil and the blade.

In an embodiment, the anvil includes a recessed area configured to receive the edge point of the blade when the first and second arms are in the closed state.

In an embodiment, a distal end of the blade is blunted. The distal end is distal to the second arm.

In an embodiment, the first and second arms are configured to move between the open and closed states within a plane defined by the first and second arms. The blade and the anvil are positioned, and configured to move, within or parallel to the plane when the first and second arms are moved between the open and closed states. When the first and second arms are moved from the open state with the blister positioned between the anvil and the cutting edge to the closed state, the plane is parallel to the flat base of the blister pill package.

In an embodiment, the blade includes a first base side; the anvil comprises a second base side; the first arm comprises a third base side; the second arm comprises a fourth base side; and the connecting portion comprises a fifth base side. The first, second, third, fourth, and fifth base sides are configured to be flat and flush to each other so as to enable the tool to be placed flat on a level surface.

In an embodiment, the first and second arms are elastically biased in a biased-open state. An external force is required to be applied to the first and second arms to move the first and second arms from the biased-open state to the closed state. In an embodiment, the first arm, the second arm, and the connecting portion is made from unitary piece of elastic material. The connecting element includes a curve-shaped member. The first and second arms extend from different ends of the curved-shaped member. In an embodiment, the first and second arms include first and second grip guides, respectively, for guiding a user as to where to apply the external force. The first and second grip guides are located next to the anvil and the blade, respectively. The first and second grip guides include an enlarged area on the respective first and second arms configured for the user to apply the external force.

In an embodiment, the hand-held cutting tool further includes a locking mechanism configured to lock the first and second arms in the closed state when the first and second arms enters the closed state. The locking mechanism includes: a first locking element extending from the first arm; a second locking element extending from the second arm, and a releasing element. The first and second locking elements are configured to releasably secure to each other to lock the first and second arms are in the closed state. The releasing element is configured to release the first and second locking elements from being secured to each other when triggered by the user.

In an embodiment, the hand-held cutting tool further includes a limiting mechanism configured to stop the first and second arms from opening beyond a limiting distance. The limiting mechanism includes: a first limiting element extending from the first arm; and a second limiting element extending from the second arm. The first and second locking elements are configured to releasably secure to each other to stop the first and second arms from opening beyond a limiting distance.

In an embodiment, the cutting edge includes an edge point configured to puncture the blister when the first and second arms are moved from the open state with the blister positioned between the anvil and the cutting edge to the closed state. In an embodiment, the cutting edge further includes a proximal edge portion and a distal edge portion. The edge point extends from the proximal and distal edge portions such that the edge point is closer to the anvil than the proximal and distal edge portions when the first and second arms are in the open state. The edge point is located between the proximal and distal edge portions. The distal edge portion extends from the edge point towards a third distal end of the blade. The proximal edge portion extends from the edge point towards the second arm. When the first and second arms are moved from the open state with the blister positioned between the anvil and the cutting edge to the closed state, the cutting edge is configured to puncture the blister with the edge point and then cut the blister with the proximal and distal edge portions. In an embodiment, the distal and proximal edge portions extend linearly away from the edge point such that distances from the distal and proximal edge portions to the anvil linearly increase away from the edge point. In an alternative embodiment, at least one of the distal and the proximal edge portions is curved and extend away from the edge point with a concavity of the curve facing the anvil. In an embodiment, the blade further includes: a first base side that is flat, and a beveled side opposite the first base side. The bevel side includes a bevel that angles down to the first base side to form the cutting edge. In an embodiment, the third distal end of the blade is blunted. In an embodiment, the anvil includes a second base side that is flat. The first base side of the blade is flush with the second base side of the anvil when the first and second arms are in the closed state. When the first and second arms are moved from the open state with the blister positioned between the anvil and the cutting edge, the first base side of the blade and the second base side of the anvil are configured to be placed flat against a flat base of the blister pill package. When the first and second arms are moved from the open state with the blister positioned between the anvil and the cutting edge to the closed state, the cutting edge is configured to puncture and cut the blister open in a base region of the blister such that the cutting edge is advanced between the one or more pills and the flat base. The blister extends from the flat base of the blister pill pack and the base region is next to the flat base. In an embodiment, the anvil further includes a first surface facing the cutting edge. The first surface is curved and has a concavity facing the cutting edge of the blade. When the first and second arms are in the closed state, an entire length of the cutting edge is adjacent to the anvil such that the cutting edge is shielded by the anvil. In an embodiment, the second base side of the anvil includes a recessed area configured to receive the edge point of the blade when the first and second arms are in the closed state. In an embodiment, the anvil further includes a stop element that extends toward the second arm. The stop element is configured to abut and stop the blister when the blister is inserted between the anvil and the blade. In an embodiment, the first and second arms are configured to move between the open and closed states within a plane defined by the first and second arms. The blade and the anvil are positioned, and configured to move, within or parallel to the plane when the first and second arms are moved between the open and closed states. When the first and second arms are moved from the open state with the blister positioned between the anvil and the cutting edge to the closed state, the plane is parallel to the flat base of the blister pill package. In an embodiment, the first arm includes a third base side; the second arm comprises a fourth base side; and the connecting portion comprises a fifth base side. The first, second, third, fourth, and fifth base sides are configured to be flat and flush to each other so as to enable the tool to be placed flat on a level surface. In an embodiment, the first and second arms are elastically biased in a biased-open state. An external force is required to be applied to the first and second arms to move the first and second arms from the biased-open state to the closed state. In an embodiment, the first arm, the second arm, and the connecting portion is made from unitary piece of elastic material. The connecting element includes a curve-shaped member. The first and second arms extend from different ends of the curved-shaped member. In an embodiment, the first and second arms include first and second grip guides, respectively, for guiding a user as to where to apply the external force. The first and second grip guides are located next to the anvil and the blade, respectively. The first and second grip guides include an enlarged area on the respective first and second arms configured for the user to apply the external force. In an embodiment, the hand-held cutting tool further includes a locking mechanism configured to lock the first and second arms in the closed state when the first and second arms enters the closed state. The locking mechanism includes: a first locking element extending from the first arm; a second locking element extending from the second arm, and a releasing element. The first and second locking elements are configured to releasably secure to each other to lock the first and second arms are in the closed state. The releasing element is configured to release the first and second locking elements from being secured to each other when triggered by the user. In an embodiment, the hand-held cutting tool further includes a limiting mechanism configured to stop the first and second arms from opening beyond a limiting distance. The limiting mechanism includes: a first limiting element extending from the first arm; and a second limiting element extending from the second arm. The first and second locking elements are configured to releasably secure to each other to stop the first and second arms from opening beyond a limiting distance.

### BRIEF DESCRIPTION OF THE DRAWINGS

A detailed description of various embodiments of the present disclosure is provided herein with reference to the accompanying drawings, which are briefly described below. The drawings are illustrative and are not necessarily drawn to scale. The drawings illustrate various embodiments of the present disclosure and may illustrate one or more embodiment(s) or example(s) of the present disclosure in whole or in part. A reference numeral, letter, and/or symbol that is used in one drawing to refer to a particular element may be used in another drawing to refer to a like element.

FIG. 1 illustrates a perspective view of an exemplary blister pill pack, according to the prior art.

FIGS. 2A and 2B illustrate top views of an exemplary hand-held cutting tool for opening blisters of a blister pill pack in open and closed states, respectively, according to an embodiment.

FIGS. 3A and 3B illustrate bottom views of the exemplary hand-held cutting tool of FIG. 2A in the open and closed states, respectively, according to an embodiment.

FIGS. 4A and 4B illustrate left- and right-side views, respectively, of the exemplary hand-held cutting tool of FIG. 2A, according to an embodiment.

FIGS. 5A and 5B illustrate a front top-perspective view and a front bottom-perspective view, respectively, of the exemplary hand-held cutting tool of FIG. 2A opened beyond a limiting distance, according to an embodiment.

FIGS. 6A and 6B illustrate top views of the exemplary hand-held cutting tool of FIG. 2A in the open and closed states, respectively, during operation to open a blister of a blister pill pack, according to an embodiment.

FIGS. 7A and 7B illustrate top and bottom views, respectively, of the exemplary hand-held cutting tool of FIG. 2A when excess external force is applied to close the tool such that a distal edge portion of a blade enters the recessed area of an anvil, according to an embodiment.

FIG. 8 illustrates a top view of an exemplary hand-held cutting tool having distal and proximal edge portions that are curved, according to an embodiment.

### DETAILED DESCRIPTION

Before the present invention is described in greater detail, it is to be understood that this invention is not limited to particular embodiments described, as such can, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges can independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

It is noted that, as used herein and in the appended claims, the singular forms “a”, “an”, and “the” include plural referents unless the context clearly dictates otherwise. It is also noted that certain ordinal terms (e.g., “first” or “second”) may be provided for ease of reference and do not necessarily imply physical characteristics or ordering. Therefore, as used herein, an ordinal term (e.g., “first,” “second,” “third,” etc.) used to modify an element, such as a structure, a component, an operation, etc., does not necessarily indicate priority or order of the element with respect to another element, but rather distinguishes the element from another element having a same name (but for use of the ordinal term). Further, an operation performed “based on” a condition or event may also be performed based on one or more conditions, or events not explicitly recited. In addition, as used herein, “exemplary” may indicate an example, an implementation, and/or an aspect, and should not be construed as limiting or as indicating a preference or a preferred example, implementation, and/or aspect. Moreover, it is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which can be readily separated from or combined with the features of any of the other several embodiments without departing from the scope or spirit of the present invention.

In one aspect of the present disclosure, a hand-held cutting tool (or device) is provided that opens a blister of a blister pill pack to enable user access to one or more pills inside the blister. The term “pill” and “pills” are used herein to refer generally and generically to any solid oral dosage form of medicine or supplements (e.g., vitamins, herbal supplements, etc.), including solid oral dosage forms such as tablets, capsules (e.g., entirely solid capsules or solid capsules filled with liquid), etc. The term “blister” is used herein to refer generally to the collective parts of the sealed cavity containing the pills (or pill)—e.g., the cavity-forming protrusion, the portion of backing layer covering the cavity, and the resulting sealed cavity that contains the pills inside.

The hand-held cutting tool includes a handle, an anvil, and a blade. The handle is configured to be held in one hand of the user and to enable the user to open and close the cutting tool. For example, the user can hold the handle and squeeze the handle to close the cutting tool with a blister positioned between the anvil and the blade. In doing so, the anvil and blade are brought towards each other to puncture and cut open the blister so that the user can access the pills inside. It should be appreciated that any description herein referencing pills (e.g., two pills) in a blister is exemplary and not intended to be limiting, and may be equally applicable to blisters with a different number of pills than two, such as a blister with one pill.

The handle includes two arms and a connecting portion. Each arm can be an elongated member having proximal and distal ends. The connecting portion extends from the proximal ends of the arms and is configured to maintain spatial separation (or distance) between the proximal ends. The arms extend away from the connecting portion to their distal ends. The anvil extends from the distal end of one arm, and the blade extends from the distal end of the other arm. The arms extend from the connecting portion in the same general direction (e.g., to the same side of the connecting portion). The lengths of the arms can vary in different embodiments but should enable the anvil and the blade to be adjacent to each other when the tool is closed.

The arms are configured to move to open and close the tool. For example, the distal ends of the arms can be moved all the way towards each other to bring the anvil and the blade adjacent to each other (e.g., abutting or next to), and the arms can be moved away from each other to spatially separate the anvil and the blade. In an embodiment, the anvil and the blade are abutting when the distal ends of the arms are moved all the way towards each. In another embodiment, the anvil and the blade are next to each other when the distal ends of the arms can be moved all the way towards each other.

References to the arms being “closed” (or in the “closed state”), the anvil and the blade being “closed” (or in the “closed state”), and to the tool being “closed” (or in the “closed state”) may be used herein and refer to the same state of the tool where the distal ends of the arms have been moved all the way towards each other with the anvil and the blade are adjacent to each other. References to the arms being “open” (or in the “open state”), the anvil and the blade being “open” (or in the “open state”), and to the tool being “open” (or in the “open state”) may be used herein and refer generally to the same state of the tool where the distal ends of the arms are out of the closed state (i.e., the distal ends of the arms are not moved all the way towards each other) and the anvil and the blade are spatially separated. The wider the arms are opened (i.e., the farther the distal ends are moved away from each other), the greater the spatial separation between the anvil and the blade.

It should be appreciated that references to the arms moving (or moved, being movable, etc.) are used herein to refer generally to the arms moving relative to each another, and can include instances where the distal end of one of the arms moves towards or away from the distal end of the other arm, and instances where the distal ends of both arms move towards or away from each other. Similarly, references to the anvil and the blade being moved (or moving, being movable, etc.) are used herein to refer to the anvil and the blade being moved relative to each other, and can include instances where either the anvil or the blade moves towards or away from the other, and instances where both the anvil and the blade move towards or away from each other.

The arms can be configured to be elastically (or resiliently) biased in the open state with the anvil and the blade spatially separated. References to the arms being in the “biased-open state,” the anvil and the blade being in the “biased-open state,” and to the tool being in the “biased-open state” may be used herein and refer generally to the same state of the tool where the arms are elastically biased open with the anvil and the blade open and spatially separated. In an embodiment, the connecting portion can be an elastic member that extends from one proximal end of one arm to the proximal end of the other arm. The elastic member can be curved shaped, for example, and provide spatial separation between the proximal ends of the arms, as well as elastically bias the arms in the biased open state. The arms, connecting portion, or both, can be elastic (or resilient) in various embodiments to bias the arms in the biased-open state and enable the arms to open and close. It should be appreciated that when references are made herein to a material being elastic, the elasticity can vary in different embodiments but should enable the tool to be strong enough to puncture and cut open a blister but elastic enough to elastically bias the arms as described herein. For example, a material with a higher elastic modulus can be used to provide a stiffer material having larger resistance to being deformed elastically when stressed by an external force. In another embodiment, a compression spring can be coupled to the arms and disposed between the arms to elastically bias the arms in the biased open state. The spring can be coupled to the arms in any suitable manner.

The user can apply an external force to the handle (e.g., squeeze the arms) to move the distal ends arms towards each other from the biased-open state. As the external force is applied, a resistive force is generated from the elastic deformation. When the user removes the external force, the resistive force returns the arms to the biased-open state. Similarly, the user can apply an external force to open the arms beyond the biased-open state, which in turn generates a resistive force that can return the arms to the biased-open state when the external force is removed.

The position (or orientation) of the arms in the biased-open state can vary in different embodiments. For example, the arms can be approximately parallel (e.g., parallel or less than 5 degrees from parallel) in the biased-open state so that the spatial separation between the distal ends of the arms is approximately equal to the spatial separation between the proximal ends of the arms. The arms can be “open wider than parallel” in the biased-open state so that the spatial separation between the distal ends is greater than the spatial separation between the proximal ends. The arms can be “open less than parallel” in the biased-open state so that the spatial separation between the distal ends is less than the spatial separation between the proximal ends. It should be appreciated that the term “parallel” is used herein generally and includes being “essentially parallel.”

The connecting portion is configured to provide spatial separation between the proximal ends of the arms. The spatial separation (or distance between the proximal ends of the arms) in the open and closed states can vary, such as in embodiments where the connecting portion is elastic. The spatial separation between the proximal ends can facilitate positioning of the anvil and the blade around a blister. The spatial separation between the proximal ends can also facilitate insertion of the anvil and the blade between rows or columns of blisters by reducing the angle of the arms when approaching a blister. For example, the arms can be maintained approximately parallel (e.g., in the biased-open state, or by the external force of the user) when approaching a blister having a width less than the spatial separation between the anvil and the blade.

Example distances of spatial separation between the proximal ends can include, but are not limited to, distances in the range of 0.25 inches to 3.5 inches, including distances in the range of 0.5 inches to 1.5 inches, such as a distance of approximately 1 inch. Typically, a single blister in a blister pill pack includes one or two pills and has a width ranging between 0.25 inches and 1.0 inches. In an embodiment, the spatial separation between the proximal ends has a distance within the range of 0.5 inches to 1.5 inches, including 0.75 inches to 1.25 inches, such as approximately 1 inch. In an embodiment with the arms biased approximately parallel, the spatial separation between the anvil and the blade in the biased-open state has a distance within the range of 0.5 inches to 1.5 inches, including 0.75 inches to 1.25 inches, such as approximately 1 inch. It should be appreciated that the example values provided herein are exemplary and not intended to be limiting; and further, that values outside of the example ranges can be implemented in other embodiments without compromising the underlying principles of the disclosure.

The arms can include grip guides configured to facilitate gripping of the handle by the user, and to guide the user to the appropriate area on the arms to apply the external force. The grip guides can include enlarged areas on the arms for the user to press on while holding the handle. The grip guides can be located next to (or near) the anvil and the blade to increase leverage for the user when applying the external force. The grip guides can also include gripping elements that can provide additional grip for the user and tactilely indicate to the user the proper placement of her hands. The gripping elements can include a plurality of grooves within the enlarged areas of the grip guides. Other types of gripping elements can be implemented in other embodiments, such as a plurality of protrusions on the enlarged areas of the grip guides.

The length of the handle can vary in different embodiments but should enable the user to hold the cutting tool 100 with one hand during operation. Example lengths of the handle can include, but are not limited to, lengths ranging between 2 inches to 5.5 inches, such as lengths ranging between 3 inches to 4 inches. In an embodiment, the length of the handle 101 is approximately 3.5 inches.

The arms and the connecting portion can be made from any suitable material that enables the arms to be closed with sufficient strength for the anvil and the blade to puncture and cut open a blister. The arms, the connecting portion, or both can be made from an elastic material (e.g., one or more natural or synthetic polymers having an elastic property) to enable the arms to be elastically biased in the biased-open state and closed under external force applied by the user. In an embodiment, the connecting portion and the arms can be integrated or made from a unitary piece of material. In another embodiment, the connecting portion and the arms can be separate elements that are fastened, adhered, molded, or otherwise coupled together. In an embodiment, the connecting portion and the arms can be made from a unitary piece of polymeric material, such as a thermoplastic elastomer (TPE) or acrylonitrile butadiene styrene (ABS). The connecting portion, the arms, or both, can be made of materials such as, but not limited to, one or more metals, metal alloys, polymeric material, or combination thereof, having an elastic property. For example, the arms can be made of a metal or metal alloy while the connecting portion made from a polymeric material having an elastic property. Alternatively, the arms can be made of a polymeric material that is elastic and the connecting portion made from a metal or metal alloy.

The anvil extends from the distal end of the arm. The anvil is configured to stabilize or hold the blister in place during operation when the blister is punctured and cut by the blade. The shape and size of the anvil can vary in different embodiments. For example, the anvil can include curved shape that is configured to stabilize the blister. The anvil can include a recessed area that is configured to receive a cutting edge of the blade when the arms are in the closed state. In an embodiment, the recessed area can vary in shape and size to receive only a portion of the cutting edge or all of the cutting edge when the arms are in the closed state. In an embodiment, the recessed area can be shaped and sized to receive at least an edge point configured to puncture the blister. In an embodiment, the anvil is made from an elastic material (e.g., one or more materials having an elastic property) that can cause the anvil to slightly deform, enabling additional portions of the cutting edge to enter the recessed area when too much external force is applied. In an embodiment, the recessed area is configured to receive the edge point, but when excess external force is applied, the recessed area deforms to receive additional portions of the cutting edge of the blade.

The anvil can include a stop element that abuts and stops the blister when the blister is inserted between the anvil and the blade. The stop element can stop the blister in the appropriate position to be cut open, as well as stabilize the blister when being punctured and cut open.

The dimensions of the anvil can vary in different embodiments but should help stabilize the target blister for the blade. Example lengths of the anvil can include, but are not limited to, lengths within the range of 0.5 inches to 2 inches, including lengths within the range of 1 inch to 1.75 inches, such as approximately 1.5 inches. Example lengths of the stop element extending towards the blade can include, but are not limited to, lengths within the range of 0.125 inches to 0.75 inches, including lengths within the range of 0.25 inches to 0.5 inches. In an embodiment, the length of the anvil 102 is approximately 0.375 inches.

The anvil can be made from any suitable material with sufficient strength to stabilize the blister when being punctured and cut open. The anvil can be made of materials such as, but not limited to, one or more metals, metal alloys, polymeric material, or combination thereof. In an embodiment, the anvil can be elastic. In an embodiment, the anvil and the arm in which it extends from can be integrated or made from a unitary piece of material. In another embodiment, the anvil and the arm in which it extends from can be separate elements that are fastened, adhered, molded, or otherwise coupled together. In an embodiment, the anvil, the arms, and the connecting portion are made from a unitary piece of polymeric material, such as a thermoplastic elastomer (TPE) or acrylonitrile butadiene styrene (ABS).

The blade extends from the distal end of the arm. The blade includes a cutting edge configured to puncture and cut open the blister. The shape of the blade can vary in different embodiments. For example, the cutting edge can be formed from a single bevel, double bevel, etc. In an embodiment, the cutting edge is formed by a single bevel on one side of the blade. The bevel on the beveled side of the blade can angle down to the flat base side of the blade to form the cutting edge. The cutting edge faces inward toward the anvil—i.e., the cutting edge is on the side of the blade that is closest to the anvil. The blade can include a blunted distal end. It should be appreciated that the term “flat” is used herein generally and includes being “essentially flat.”

The cutting edge can include an edge point, a distal edge portion, and a proximal edge portion. The edge point can be located between the distal and proximal edge portions. The edge point can extend from the cutting edge such that the edge point is closer to the anvil than the distal and proximal edge portions. When the arms are moved from the open state to closed state to cut open a blister, the edge point contacts and punctures the blister, then the distal and proximal edge portions further cut the blister open.

The shape of the distal and proximal edge portions can vary in different embodiments. In an embodiment, the distal and proximal edge portions extend linearly away from the edge point. In other embodiments, at least one of the distal and proximal edge portions can be curved and extend away from the edge point with the concavity of the curve facing the anvil. The degree of curvature can vary for the distal and proximal edge portions. In an embodiment, one of the distal and proximal edge portions is curved and the other linear.

The anvil and the blade can be configured such that the anvil is adjacent to, and extends across, the cutting edge of the blade when the tool is in the closed state. In this way, the cutting edge is shielded by the anvil in the closed state. The cutting edge can be shielded by abutting the anvil, being next to but not abutting the anvil, or a combination thereof. For example, in an embodiment, the edge point can be shielded by abutting the anvil inside the recessed area, while the distal and proximal edge portions are shielded by being located next to the anvil. In another embodiment, the edge point and at least some of the distal and proximal edge portions can be shielded by abutting the anvil inside the recessed area, while the remainder of the distal and proximal edge portions are shielded by being located next to the anvil. In yet another embodiment, the entire cutting edge is shielded by abutting the anvil. In yet another embodiment, the entire cutting edge is shielded by being located next to the anvil when the arms are in the closed state. At a distal end of the tool, the blunted distal end of the blade and the distal end of the anvil can prevent the user from contacting the cutting edge when the tool is in the closed state.

The dimensions of the blade can vary in different embodiments. Example lengths of the span of the cutting edge can include, but are not limited to, lengths within the range of 0.25 inches to 1.5 inches, including lengths within the range of 0.5 inches to 1.25 inches. In an embodiment, the length of the span of the cutting edge 117 is approximately 1 inch. Example widths of the blade 103 (i.e., from the edge point to an outer side of the blade opposite the edge point) can include, but are not limited to, widths within the range of 0.125 inches to 1 inch, including lengths within the range of 0.375 inches to 0.75 inches. In an embodiment, the length of the span of the cutting edge 117 is approximately 0.625 inches.

The blade can include a tang that can be used to secure the blade to the arm, such as by screws, rivets, pins, fasteners, or other suitable manner. In an embodiment, the tang is secured to the arm with screws. In an embodiment, the arm can be molded around the tang. The blade can be made of any material strong enough to puncture the blister and sharp enough (or capable of being sharpened enough) to cut through the blister, such as one or more metals, metal alloys, or combination thereof. In an embodiment, the blade is made of one or more metals, metal alloys, or combination thereof, and coupled to the arm made of a polymeric material. In another embodiment, the blade and the arm can be integrated or made from a unitary piece of material, such as one or more metals, metal alloys, or combination thereof.

The arms are configured to move within the plane defined by the arms (also referred to herein as “plane P”). The anvil is configured to move within the plane P between the open and closed states. The cutting edge is positioned within (or extends within) the plane P and is configured to move within the plane P between open and closed states. In some implementations, the anvil and the blade can be offset from the arms (e.g., located below or above the plane of the arms) in which case the anvil and the blade would move parallel to the plane P of the arms. Such configurations and movement enable the anvil and the blade to be placed around the blister and closed to puncture and cut open the blister—in a manner that minimally obstructs the user's view of the blister.

The tool can be configured to be flat on the side that contacts the flat base of the blister pill pack. The base side of the anvil, the base side of the blade, a base side of the connecting portion, and base sides of the respective arms can be flush so as to enable the tool to be placed flat on a level surface (e.g., a flat base of the blister pill pack, a table surface, or both). In addition, such flush configuration can be beneficial to keep the cutting edge parallel to the flat base and in a base region of the blister when puncturing and cutting the blister open. It should be appreciated that the terms “level” and “flush” are used herein generally and include being “essentially level” and “essentially flush,” respectively.

The tool can include a locking mechanism that is configured to secure the arms in the closed state when the arms are closed. For example, the locking mechanism can include locking elements configured to secure (e.g., hook) together when the arms enter the closed state. The locking mechanism can also include a releasing element that can be triggered by the user to unlock the tool. The locking mechanism can be beneficial to stabilize the cutting tool in the closed state once the blister is cut open, and can serve as a safety mechanism to keep the cutting edge shielded by the anvil when the cutting tool is not being used.

In another embodiment, the arms can be configured to open and close without locking. Instead, the locking mechanism can be activated by the user. For example, the connecting portion and the arms can be made from an elastic material such that the arms can bend slightly when activating the locking mechanism. For instance, when the user wants to activate the locking mechanism, the user can close the arms and, at the same time, press the arms in opposite directions (orthogonal to the plane P) so that the locking elements are brought together to secure to each other and lock the tool in the closed state.

The cutting tool 100 can include a limiting mechanism that limits how far the arms can be opened (or spread apart) in the open state. The limiting mechanism can be beneficial to serve as a safety mechanism to keep the tool from opening too far and dangerously exposing the blade. The limiting mechanism can include limiting elements that extend from the arms and that abut each other when the arms are opened a threshold distance from one another (also referred to herein as the “limiting distance”). The limiting mechanism can be configured to prevent the arms from being opened beyond the limiting distance. In an embodiment, the arms can be biased open at a smaller distance apart than the limiting distance. In another embodiment, the limiting mechanism can be configured to cooperatively bias the arms at the limiting distance.

In an embodiment, the limiting elements can be configured to release from each other to allow the arms to open beyond the limiting distance. For example, the arms and the coupling portion can be elastic to allow the user to slightly bend one or both of the arms away from each other (e.g., in orthogonal directions to the plane P) to prevent the limiting elements from abutting, enabling the arms to open beyond the limiting distance.

In use, the user can hold the handle of the cutting tool with one hand and the blister pill pack in the other hand. Alternatively, the blister pill pack can be placed on a surface such as a table. If the tool is locked in the closed state, then the user can unlock the arms from the closed state, such as by pressing on the releasing element. As a result, the tool is unlocked from the closed state and the arms enter the biased-open state.

While the arms are in the open state, the user positions the anvil and blade flat against a flat base of a blister pill pack. The user can move the anvil and the blade around the target blister so that the blister is positioned between the anvil and the cutting edge of the blade, preferably with the edge point positioned in the approximate middle of the side of the blister. In some instances, the user can push the tool towards the blister until the blister abuts the stop element with the edge point positioned on the side of the blister. In some instances, such as with small blisters, the stop element may not be used and the user can visually position the edge point in the approximate middle of the side of the blister.

If the spatial separation between the anvil and the blade in the biased-open state is significantly more than the width of the blister, then the user can squeeze the grip guides to apply just enough external force to the arms to reduce the spatial separation to an optimal size to position the anvil and the blade around the blister. If the spatial separation between the anvil and the blade in the biased-open state is less than the width of the blister, then the user can position the distal ends of the anvil and the blade against the blister and push the tool towards the blister. The pressure from the blister can push the anvil and the blade open wider as they slide along the sides of the blister until the blister abuts the stop element or is in the approximate middle of the side of the blister.

Once the blister is in the appropriate position, the user can apply an external force (e.g., squeeze) to the grip guides of the arms with the corresponding fingers of one hand to move the arms into the closed state. As the external force is applied, the anvil is pressed against the blister, which stabilizes the blister as the edge point of the blade contacts and punctures the blister. The edge point punctures the base region of the cavity-forming protrusion of the blister, and then the distal and proximal edge portions of the cutting edge further cut open the base region from the point of puncture. The cutting edge of the blade is advanced between the pills and the flat base of the blister pill pack.

In an embodiment, when sufficient external force is applied, the cutting edge is advanced until the blade abuts the anvil with the edge point positioned in the recessed area of the anvil. In another embodiment, some or all of the distal and proximal edge portions can enter the recessed area when the blade abuts the anvil. In yet another embodiment, the anvil can be made from an elastic material that causes the anvil to slightly deform after contact with the blade, such as when too much external force is applied, causing additional portions of the blade to enter the recessed area.

In one embodiment, as the arms are moved into the closed state, the locking mechanism locks the tool in the closed state. As the external force from the user is removed, the tool remains in the closed state. In another embodiment, the locking mechanism is configured to be activated by the user when desired. When the user wants to use the tool again to cut open another blister, the user can unlock the tool (e.g., press on the releasing element) so the arms return to their biased-open state positions.

In an embodiment, the cutting edge is configured to cut entirely through the cavity-forming protrusion of the blister. In another embodiment, the cutting edge is configured to not cut entirely through the cavity-forming protrusion of the blister, leaving a portion still attached to the flat base.

When the tool enters the closed state, the cutting edge of the blade is shielded by the anvil. This allows the user to handle the tool in a safe manner that does not expose the cutting edge. The user can then store the tool as it is locked and ready for storage. When the user wants to use the tool again to cut open another blister, the user can press on the releasing element to unlock the arms from the closed state.

In some instances, such as with large blisters, the user may be required to open the arms beyond the limiting distance in order to position the anvil and the blade around a blister. In such case, the user can circumvent the limiting mechanism to enable the arms to open beyond the limiting distance. The user can then position the anvil and the blade around the blister until the blister is abutting the stop element or until the edge point is in the approximate middle of the side of the blister. As described above, the user can apply external force to the arms to puncture and cut open the blister.

The locking mechanism (e.g., the locking elements and the releasing element) and limiting mechanism (e.g., the limiting elements) can be made from any suitable material including, but not limited to, one or more metals, metal alloys, polymeric material, or combination thereof In an embodiment, the locking mechanism and the limiting mechanism can be elastic. In an embodiment, the locking mechanism, the limiting mechanism, the arms, the coupling portion, and the anvil are integrated or made from a unitary piece of polymeric material, such as a thermoplastic elastomer (TPE) or acrylonitrile butadiene styrene (ABS). In another embodiment, the locking mechanism and the limiting mechanism can be separate elements that are fastened, adhered, molded, or otherwise coupled together to the arms.

Aspects of different embodiments have been described in varying detail above. Embodiments will now be described in further detail in terms of the exemplary embodiments shown in the figures. It should be appreciated that variations from the example embodiments shown in the figures can be included in other embodiments without compromising the underlying principles of the present disclosure. These variations can include, for instance, the variations described above for the hand-held cutting tool.

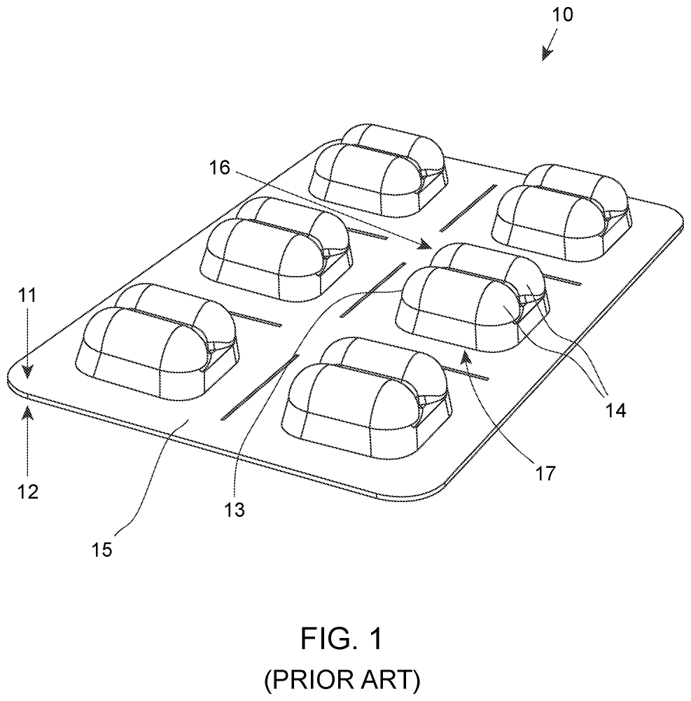

FIG. 1 illustrates a perspective view of an exemplary blister pill pack, according to the prior art. In FIG. 1 a blister pill pack 10 is shown including a tray 11 and a backing layer 12. The tray 11 includes six cavity-forming protrusions, of which one is shown as representative cavity-forming protrusion 13. The six cavity-forming protrusions extend from a flat base 15 of the tray 11. The tray 11 can be formed from a single thermoformed plastic, for instance, and can have another number of cavity-forming protrusions in other implementations. The tray 11 is shown including two pills 14 located in the cavity of the cavity-forming protrusion 13. Usually, one or two pills are located within a single cavity-forming protrusion of a typical blister pill pack.

The backing layer 12 can be applied to (e.g., heat sealed or otherwise adhered to) the tray 11 so that the pills 14 are sealed within the cavities of the cavity-forming protrusions 13. The backing layer 12 may include one or more layers of, for example, paperboard, lidding seal of aluminum foil, plastic, or combination thereof. The backing layer 12 is configured to be penetrable where the backing layer 12 covers the cavities of the cavity-forming protrusions 13. For example, a portion (not shown in FIG. 1) of the backing layer that covers the cavity formed by the cavity-forming protrusion 13 can include a penetrable lidding seal (e.g., aluminum foil, plastic film, etc.), one or more perforated materials (e.g., paperboard, plastic, or combination thereof) that can be penetrated using force, etc. The blister pill pack 10 is shown including six blisters extending from the flat base 15, of which one is shown as representative blister 16. The blister 16 includes the cavity-forming protrusion 13, the portion of the backing layer 12 that covers the cavity of the cavity-forming protrusion 13, and the resulting sealed cavity that contains the pills 14a,14b inside. The blister 16 includes a base region 17 corresponding to a portion of the cavity-forming protrusion 13 that is next to (or near) the flat base 15.

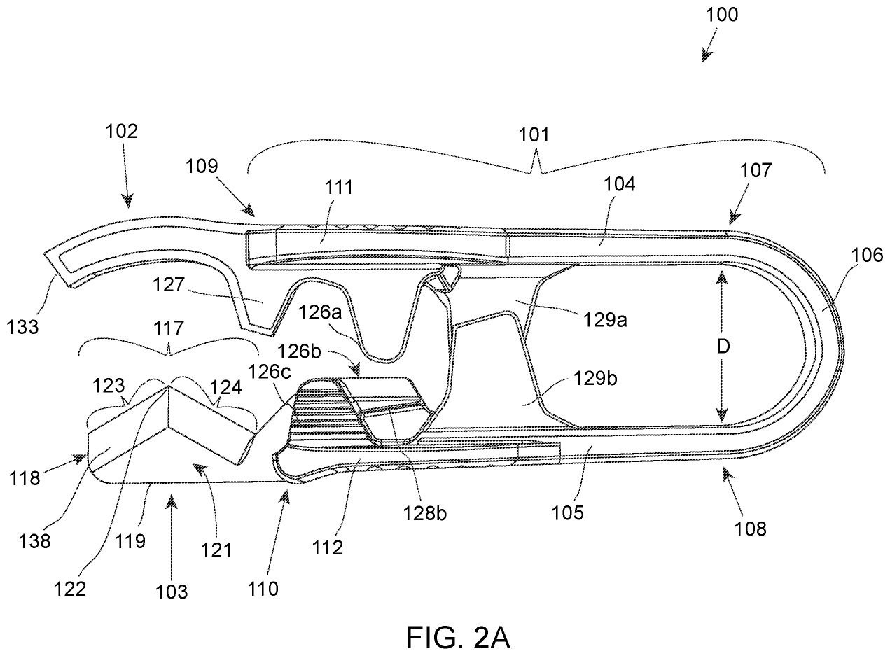

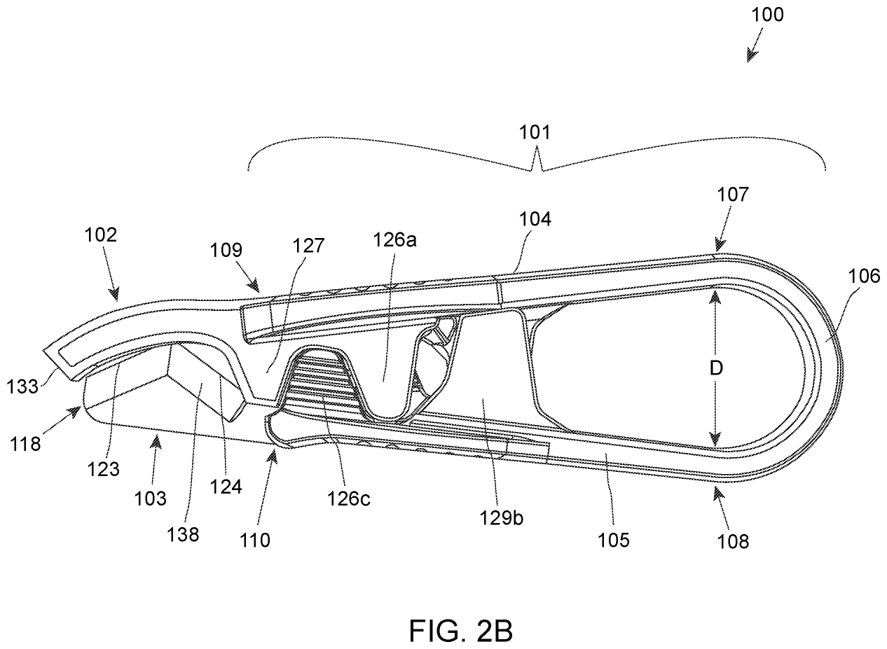

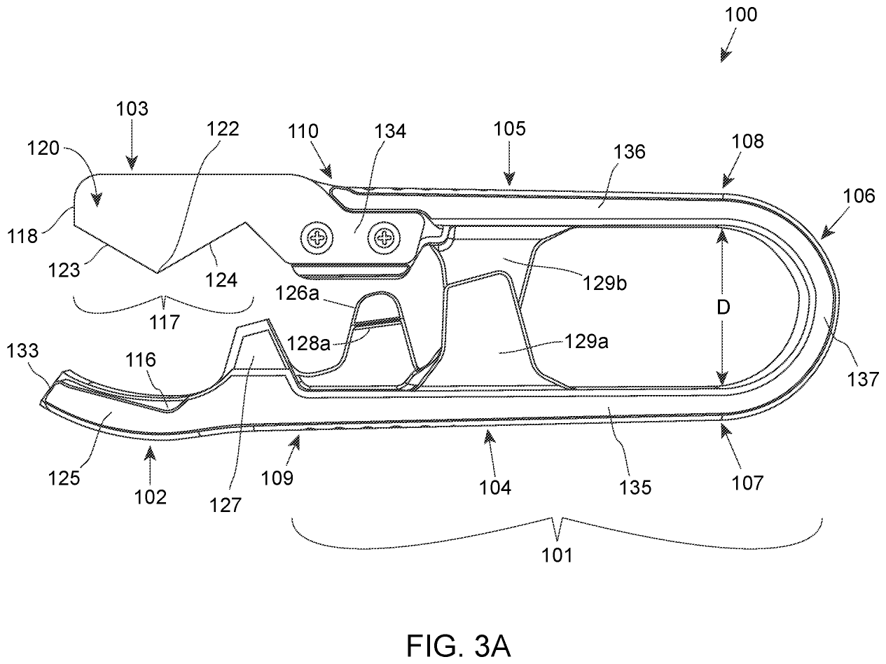

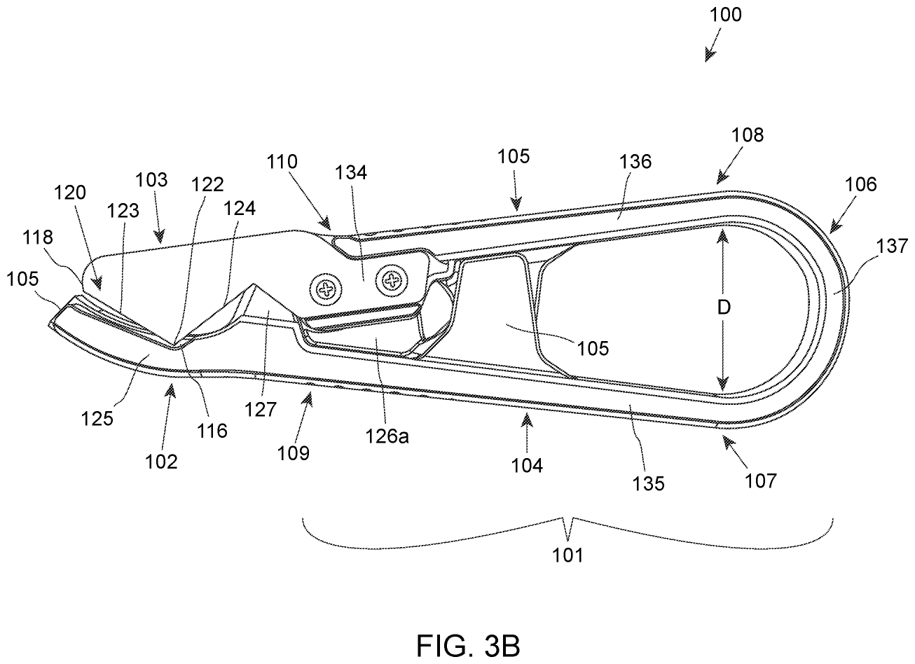

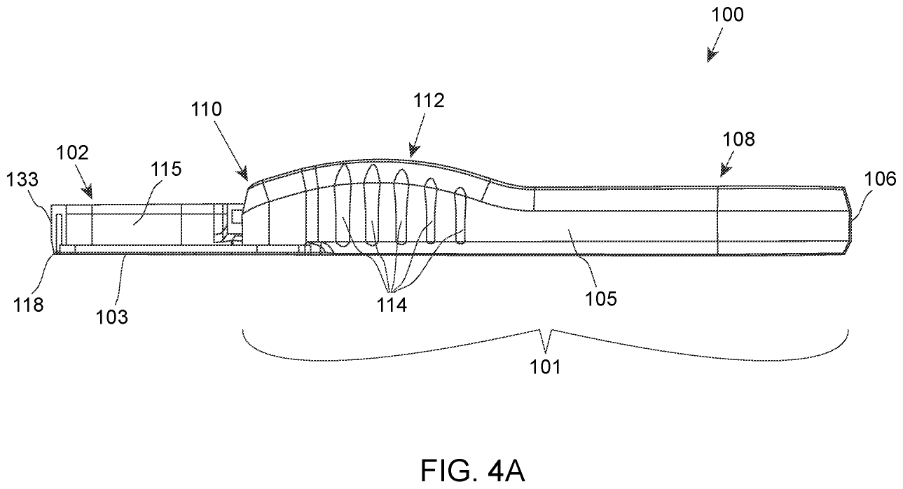

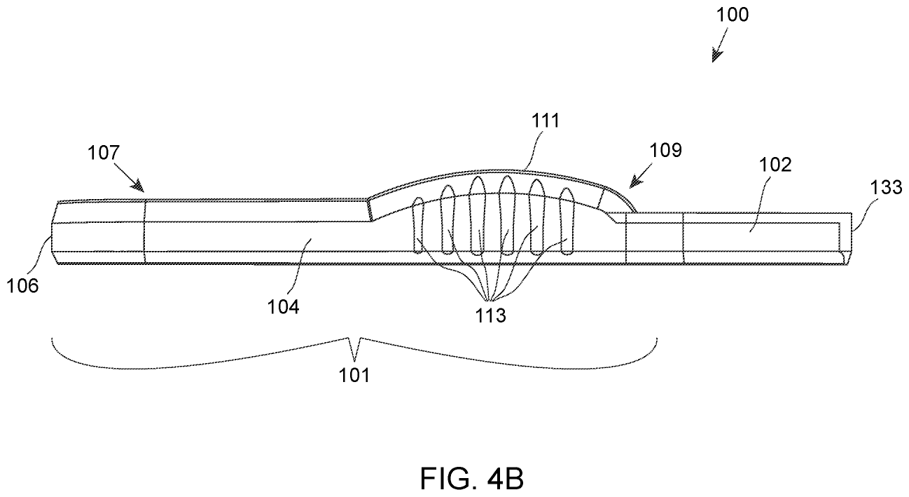

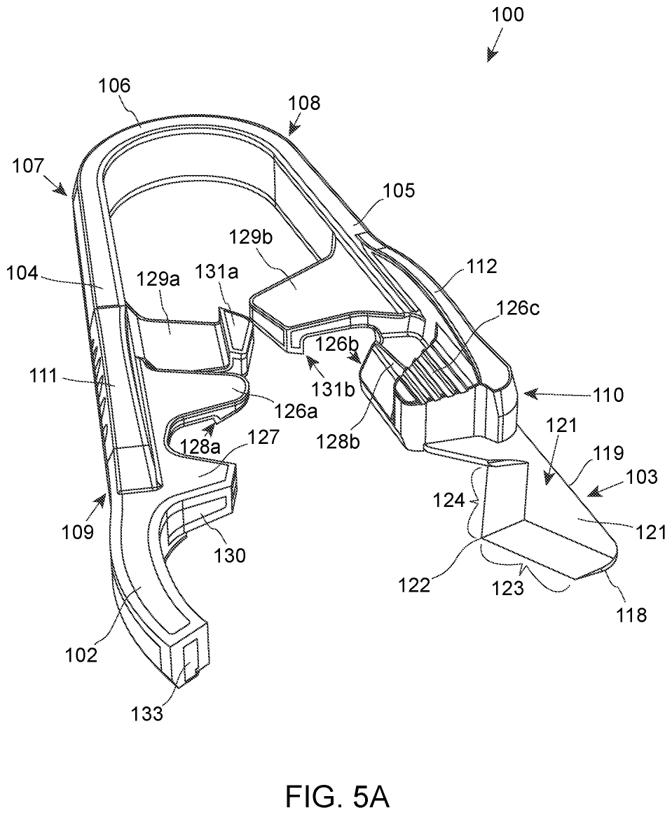

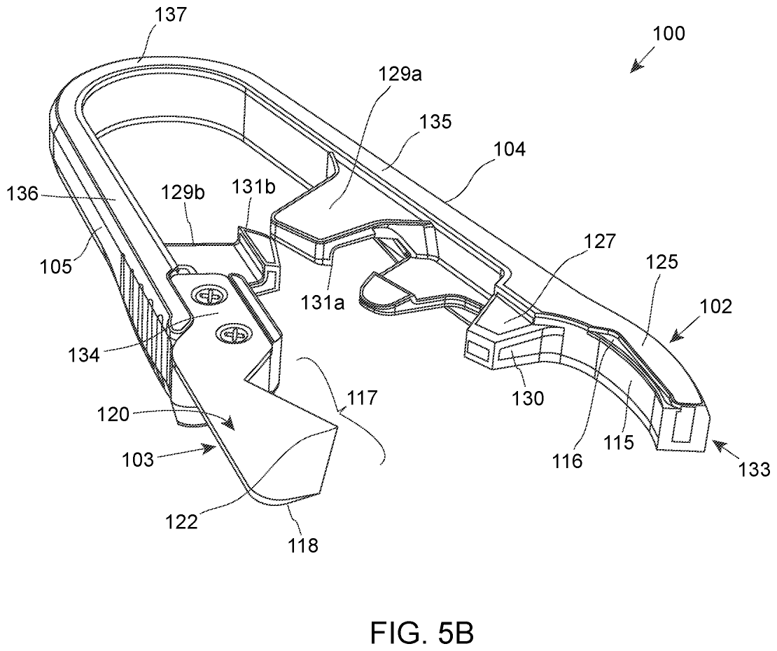

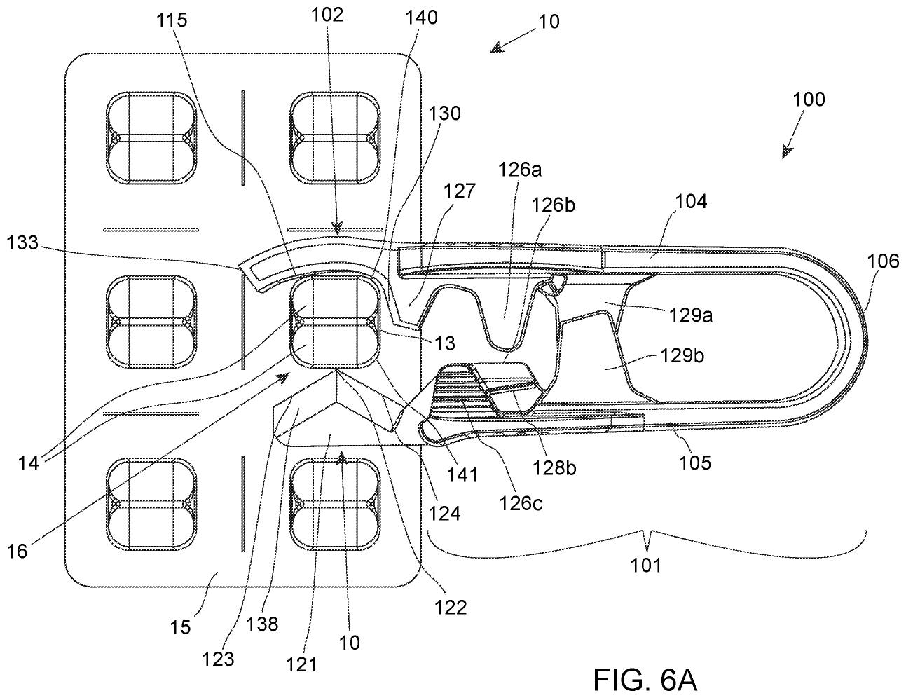

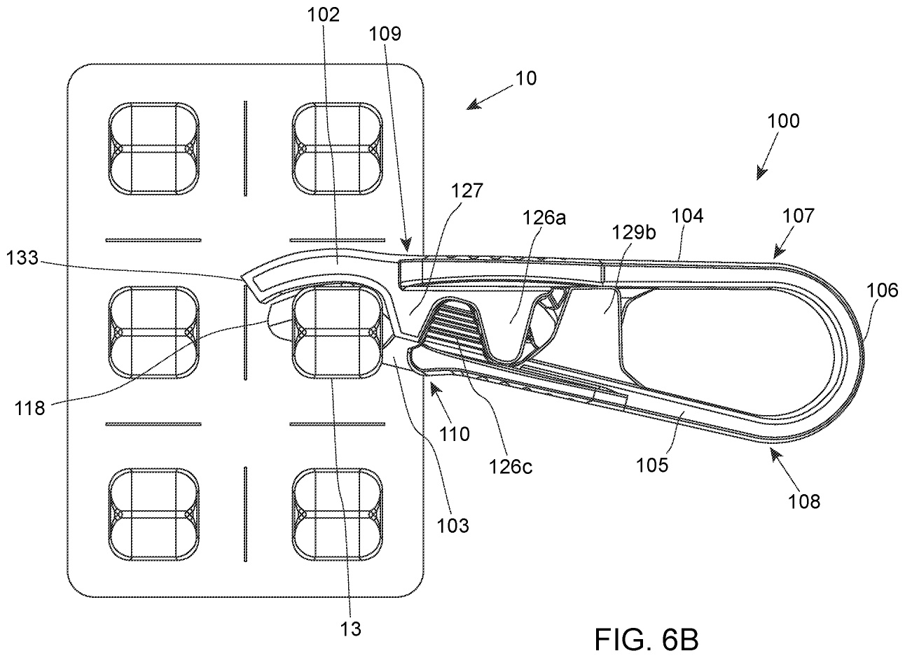

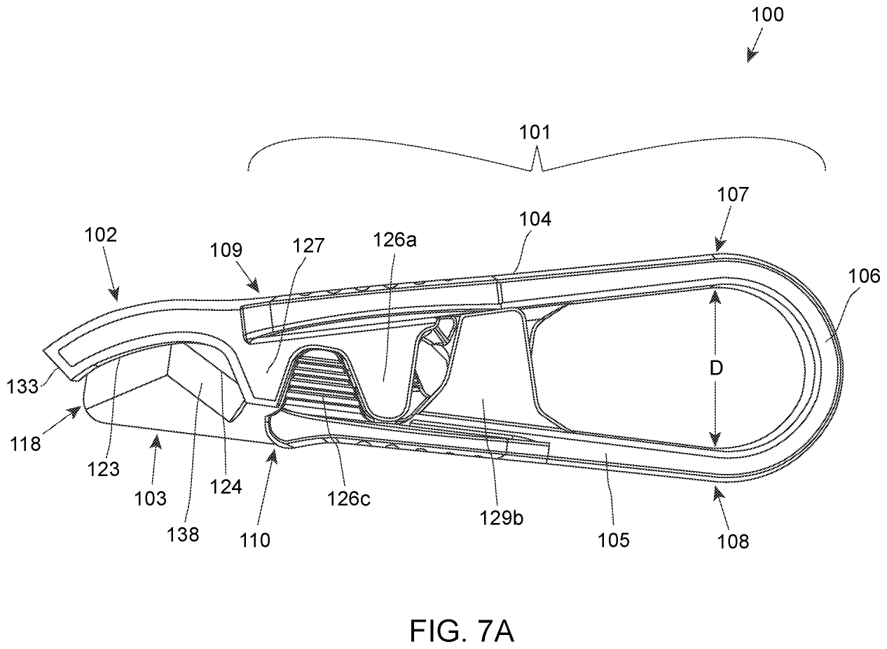

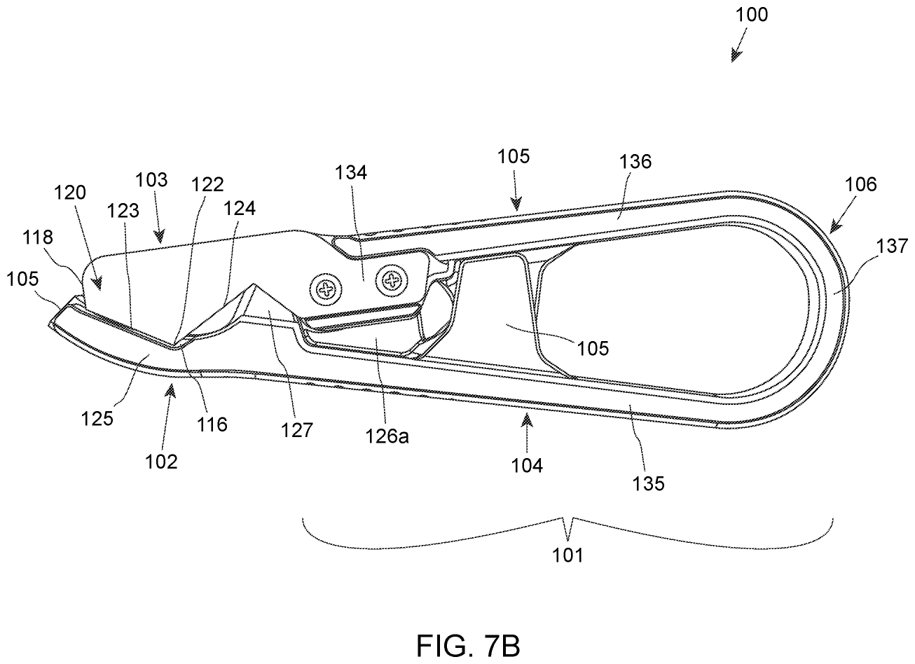

FIGS. 2A and 2B illustrate top views of an exemplary hand-held cutting tool for opening blisters of a blister pill pack in open and closed states, respectively, according to an embodiment. FIGS. 3A and 3B illustrate bottom views of the exemplary hand-held cutting tool of FIG. 2A in the open and closed states, respectively, according to an embodiment. FIGS. 4A and 4B illustrate left- and right-side views, respectively, of the exemplary hand-held cutting tool of FIG. 2A, according to an embodiment. FIGS. 5A and 5B illustrate a front top-perspective view and a front bottom-perspective view, respectively, of the exemplary hand-held cutting tool of FIG. 2A opened beyond a limiting distance, according to an embodiment. FIGS. 6A and 6B illustrate top views of the exemplary hand-held cutting tool of FIG. 2A in the open and closed states, respectively, during operation to open a blister of a blister pill pack, according to an embodiment. FIGS. 7A and 7B illustrate top and bottom views of the exemplary hand-held cutting tool of FIG. 2A when excess external force is applied to close the tool such that the distal edge portion of the blade enters the recessed area of the anvil, according to an embodiment. FIGS. 2A, 2B, 3A, 3B, 4A, 4B, 5A, 5B, 6A, 6B, 7A, and 7B are described herein together. For the sake of brevity and clarity, reference numbers for every feature of the hand-held cutting tool may not necessarily be indicated in each figure. Furthermore, the exemplary blister pill pack of FIG. 1 is provided to facilitate understanding of the hand-held cutting tools described herein and shown in the figures. It should be appreciated that any references to the blister pill pack 10 of FIG. 1, or any component thereof such as the representative blister 16, used to describe the hand-held cutting tools shown in the figures are not intended to be limiting, and may be equally applicable to the use of the hand-held cutting tools with blister pill packs in general (e.g., other types of blister pill packs than shown), or any other components thereof in general (e.g., other types of blisters than shown, other locations of the blister in the blister pill pack than shown).

A hand-held cutting tool for opening blisters of a blister pill pack is shown in FIGS. 2A, 2B, 3A, 3B, 4A, 4B, 5A, 5B, 6A, 6B, 7A, and 7B. As shown in the figures, a hand-held cutting tool 100 includes a handle 101, an anvil 102, and a blade 103. The handle 101 is shown including arms 104,105 and a connecting portion 106. The connecting portion 106 extends from proximal ends 107,108 of the respective arms 104,105. The connecting portion 106 maintains spatial separation (represented as distance D in the figures) between the proximal ends 107,108 of the arms 104,105. The arms 104,105 extend away from the connecting portion 106 to distal ends 109,110 of the arms 104,105, respectively. The anvil 102 extends from the distal end 109 of the arm 104. The blade 103 extends from the distal end 110 of the arm 105. The arms 104,105 extend from the connecting portion 106 in the same general direction (e.g., to the same side of the connecting portion 106). The lengths of the arms 104,105 can vary in different embodiments but should enable the anvil 102 and the blade 103 to be adjacent to each other when the tool 100 is closed.

The arms 104,105 are configured to move to open and close the tool 100. For example, the distal ends 109,110 can be moved (e.g., by a user) towards each other to bring the anvil 102 and the blade 103 adjacent to each other, and away from each other so the anvil 102 and the blade 103 are spatially separated. In a preferred embodiment, the anvil 102 and the blade 103 are abutting when the distal ends 109,110 are moved all the way towards each. The wider the arms 104,105 are opened (i.e., the farther the distal ends 109,110 are moved away from each other), the greater the spatial separation between the anvil 102 and the blade 103.

The connecting portion 106 includes an elastic curve-shaped member that enables the arms 104,105 to open and close. The arms 104,105 extend from different ends of the curved-shaped member. The connecting portion 106 is configured to elastically bias the arms 104,105 open with the anvil 102 and the blade 103 spatially separated. The user can apply external forces to close the arms 104,105. For example, the user can grip and squeeze the handle 101 to apply an external force to the arms 104,105 to move the distal ends 109,110 of the respective arms 104,105 towards each other, such as to close the arms 104,105. As the external force is applied, the elastic curve-shaped member 106 is deformed and a resistive force generated from the elastic deformation. When the user removes the external force, the resistive force returns the arms 104,105 to the biased-open state. Similarly, the user can apply an external force to open the arms 104,105 beyond the biased-open state, which in turn deforms the elastic curve-shaped member 106 to generate the resistive force that can return the arms 104,105 to the biased-open state when the external force is removed.

The position of the arms 104,105 in the biased-open state can vary in different embodiments. In an embodiment, the arms 104,105 can be “open wider than parallel” in the biased-open state so that the spatial separation between the distal ends 109,110 is greater than the spatial separation between the proximal ends 107,108. In another embodiment, the arms 104,105 can be “open less than parallel” in the biased-open state so that the spatial separation between the distal ends 109,110 is less than the spatial separation between the proximal ends 107,108. In a preferred embodiment, the arms 104,105 are approximately parallel (e.g., parallel or less than 5 degrees from parallel) in the biased-open state so that the spatial separation between the distal ends 109,110 is approximately equal to the spatial separation between the proximal ends 107,108.

The connecting portion 106 is configured to provide spatial separation (shown by reference letter D in the figures) between the proximal ends 107,108 of the arms 104,105. The distance of spatial separation between the proximal ends 107,108 can vary in different embodiments, such as described previously herein. In a preferred embodiment, the spatial separation between the proximal ends 107,108 has a distance within the range of 0.75 inches to 1.25 inches, such as approximately 1 inch.

The arms 104,105 are shown including grip guides 111,112, respectively. The grip guides 111,112 are configured to facilitate the gripping of the handle 101 and guide the user to an appropriate area on the arms 104,105 to apply the external force. The grip guides 111,112 include enlarged areas on the arms 104,105 for the user to press on while holding the handle 101. For example, the user can place a thumb on the grip guide on one arm (e.g., the grip guide 112 on the arm 105) while wrapping fingers around the other arm (e.g., the arm 104) with the index finger on the grip guide of the other arm (e.g., the grip guide 111 of the arm 104). The grip guides 111,112 are located next to the anvil 102 and the blade 103, respectively, which can increase leverage for the user when applying the external force. The grip guides 111,112 also include respective gripping elements 113,114 that can provide additional grip for the user and tactilely indicate to the user the proper placement of her hands. The gripping elements 113,114 include a plurality of grooves within the enlarged areas of the grip guides 111,112, respectively.

The length of the handle 101 can vary in different embodiments, such as described previously herein. In a preferred embodiment, the handle 101 includes a length in the range of 3 inches to 4 inches, such as 3.5 inches.

The connecting portion 106 can be made from one or more materials that are sufficiently elastic to bias the arms 104,105 in the open state and to enable the arms 104,105 to move to the closed state under the external force applied by the user. The material of the connecting portion can vary in different embodiments, such as described previously herein. The manner in which the connecting portion and the arms 104,105 are connected or coupled can also vary in different embodiments, such as described previously herein. In a preferred embodiment, the connecting portion 106 and the arms 104,105 are integrated or made from a unitary piece of polymeric material, such as a thermoplastic elastomer (TPE) or acrylonitrile butadiene styrene (ABS).

The anvil 102 is configured to stabilize or hold the blister 16 in place during operation when the blister is punctured and cut by the blade 103. The anvil 102 includes a curved shape configured to stabilize the blister 16 when being punctured and cut open. A base side 125 of the anvil 102 is flat and configured to be placed against the flat base 15 of the blister pill package 10 when cutting open the blister 16. The anvil 102 includes a surface 115 that abuts against the blister 16 to stabilize the blister when being punctured and cut by the blade 103. The surface 115 of the anvil 102 is curved such that the concavity faces the blade 102.

The anvil 102 includes a recessed area 116 in the base side 125 of the anvil 102. The recessed area 116 is shaped and sized to receive a portion of a cutting edge 117 of the blade 103, including an edge point 122 configured to puncture the blister. In a preferred embodiment, recessed area 116 is shaped and sized to receive at least the edge point 122 when the arms 104,105 are in the closed state. Further, the anvil 102 is made from an elastic material that can cause the anvil 102 to slightly deform, enabling additional portions of the cutting edge 117 (e.g., a distal edge portion 123 described later herein) to enter the recessed area 116 when excess external force is applied.

The anvil 102 includes a distal end 133 distal to the arm 104, and a stop element 127 at an end of the anvil 102 that is proximal to the arm 104. The stop element 127 extends towards the blade 103 and includes a surface 130 that can abut and stop the blister 16 when the blister 16 is inserted between the anvil 102 and the blade 103. For example, the user can insert the blister 16 between the anvil 102 and the blade 103 by moving the anvil 102 and the blade 103 around the sides of the blister 16 until the stop element 127 abuts the blister and stops the blister 16 in an appropriate position to be punctured and cut open. The blister 16 is then stabilized by the surface 130 and the surface 115 so the blade 103 can puncture and cut the blister open.

The dimensions of the anvil 102 can vary in different embodiments, such as described previously herein. In a preferred embodiment, a longitudinal length of the anvil 102 (e.g., from the stop element 127 to the distal end 133) is within the range of 1 inch to 1.75 inches, such as approximately 1.5 inches. In a preferred embodiment, a length in which the stop element 127 extends towards the blade 103 is within the range of 0.25 inches to 0.5 inches, such as approximately 0.375 inches.

The material of the anvil 102, and the manner in which the anvil 102 connects or couples to the arm 104, can vary in different embodiments, such as described previously herein. In a preferred embodiment, the anvil 102 and the arm 104 are integrated or made from a unitary piece of polymeric material, such as a thermoplastic elastomer (TPE) or acrylonitrile butadiene styrene (ABS).

The blade 103 is shown including the cutting edge 117, a distal end 118, and an outer side 119. The distal end 118, which is blunted, and the outer side 119 are not sharp and safe for the user to touch without being cut. The cutting edge 117 is sharp and configured to puncture and cut open the blister 16. The cutting edge 117 is formed by a single bevel 138. The blade 103 includes a base side 120 and a beveled side 121. The base side 120 of the blade 103 is flat and configured to be placed against the flat base 15 of the blister pill package 10 when cutting open the blister 16. The beveled side 121 is opposite the base side 120 and faces away from the flat base 15 of the blister pill package 10 when cutting open the blister 16. The beveled side 121 includes the bevel 138, which angles down to the base side 120 to form the cutting edge 117. The cutting edge 117 faces inward toward the anvil 102.

The cutting edge 117 includes the edge point 122, a distal edge portion 123, and a proximal edge portion 124. The edge point 122 is located between the distal and proximal edge portions 123,124. For example, the convergence point of the distal edge portion 123 and the proximal edge portion 124 forms the edge point 122. The edge point 122 extends from the rest of the cutting edge 117 and is closer to the anvil 102 than the distal and proximal edge portions 123,124. The base side 125 of the anvil 102 and the base side 120 of the blade 103 are configured to be placed against the flat base 15 of the blister pill package 10 when cutting open the blister 16. When the arms 104,105 are moved from the open state to the closed state to cut open the blister 16, the edge point 122 contacts and punctures the blister 16, then the distal and proximal edge portions 123,124 further cut the blister 16 open. When the arms 104,105 are in the closed state, the cutting edge 117 of the blade 103 is adjacent to the surface 115 of the anvil 102 with the edge point 122 inside the recessed area 116.

The distal and proximal edge portions 123,124 extend linearly away from the edge point 122. The edge point 122 is located at the vertex of the distal and proximal edge portions 123,124. The distal edge portion 123 extends linearly away from the edge point 122 to the blunted distal end 118 of the blade 103. The proximal edge portion 124 extends linearly away from the edge point 122 towards the distal end 110 of the arm 105. The distal and proximal edge portions 123,124 extend linearly away from the edge point 122 such that the distance from the distal and proximal edge portions 123,124 to the anvil 102 linearly increases away from the edge point 122.

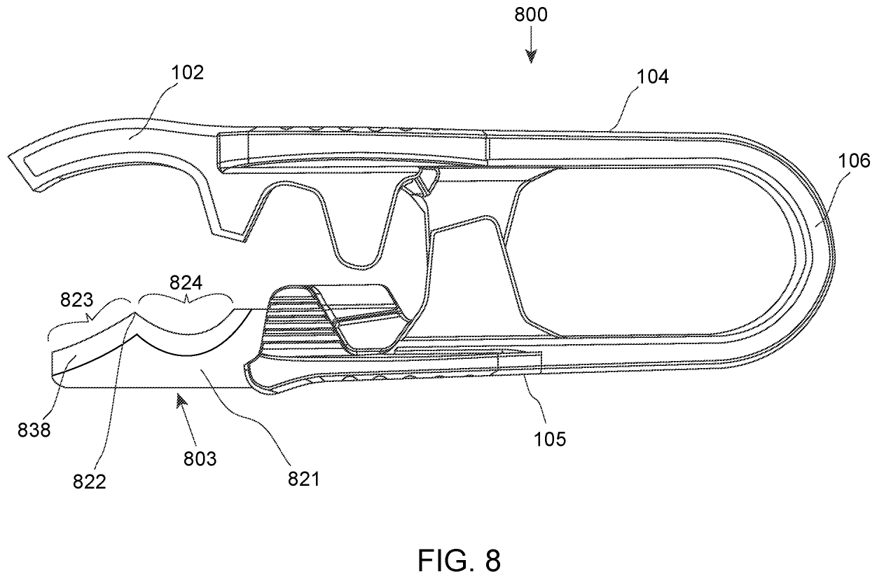

The distal and proximal edge portions 123,124 can have different shapes in other embodiments, such as described previously herein. FIG. 8 illustrates a top view of an exemplary hand-held cutting tool having distal and proximal edge portions that are curved, according to an embodiment. As shown in FIG. 8, a hand-held cutting tool 800 is shown including the arms 104,105, the connecting portion 106, the anvil 102 extending from the arm 104, and a blade 803 extending from the arm 105. The blade 803 is shown including an edge point 822 and distal and proximal edge portions 823,824, which collectively form the cutting edge. The distal and proximal edge portions 823,824 are both curved and extend away from the edge point 822 with the concavities of the curves facing the anvil 102. The cutting edge is formed by a bevel 838 such that the blade 803 includes a beveled side 821 and a base side (not shown in FIG. 8) that is opposite the beveled side 821. The beveled side 821 includes the bevel 838, which angles down to the base side to form the cutting edge. The edge point 822 is located in between the distal and proximal edge portions 823,824. The edge point 822 extends from the distal and proximal edge portions 823,824 and is closer to the anvil 102 than the distal and proximal edge portions 823,824. The proximal edge portion 824 has a degree of curvature greater than that of the distal edge portion 823. In another embodiment, the distal edge portion 823 can have a degree of curvature greater than or approximately equal to the proximal edge portion 824. In yet another embodiment, the one of the distal and proximal edge portions 823,824 can be linear and not curved. It should be appreciated that not all common features and functions of the tool 800 and the tool 100 are repeated here for the sake of clarity and brevity. Accordingly, the description herein for the common features and functions of the tool 100 in FIGS. 2A, 2B, 3A, 3B, 4A, 4B, 5A, 5B, 6A, 6B, 7A, and 7B may also be applicable here for the tool 800 in FIG. 8.

Returning to FIGS. 2A, 2B, 3A, 3B, 4A, 4B, 5A, 5B, 6A, 6B, 7A, and 7B, the anvil 102 and the blade 103 are configured such that the surface 115 of the anvil 102 is adjacent to, and extends across, the cutting edge 117 when the cutting tool 100 is in the closed state. In this way, the entire cutting edge 117 is shielded by the anvil 102 in the closed state. Further, the blunted distal end 118 and the distal end 133 of the anvil 102 provide protection to the user from the cutting edge 117 when the tool 100 is in the closed state.

Some or all of the cutting edge 117 can be shielded by abutting the anvil 102 or being located next to the anvil 102, such as described previously herein. As easily seen in FIGS. 2B and 3B, the edge point 122 abuts the anvil 102 within the recessed area 116 of the blade when the arms 104,105 are in the closed state. Further, at least some of the distal and proximal edge portions 123,124 are shielded by being located next to the anvil 102. In an embodiment, the anvil 102 can be made from an elastic material that causes the anvil 102 to slightly deform and enable the distal edge portion 123 to completely enter the recessed area 116 when excess external force is applied, as shown in FIGS. 8A and 8B.

The dimensions of the blade 103 can vary in different embodiments, such as described previously herein. In a preferred embodiment, a length of the span of the cutting edge 117 is within the range of 0.5 inches to 1.25 inches, such as approximately 1 inch. Further, a width of the blade 103 (i.e., from the outer side 119 to the edge point 122) is within the range of 0.375 inches to 0.75 inches, such as approximately 0.625 inches.

The blade 103 includes a tang 134 that can be used to secure the blade 103 to the arm 105. The tang 134 and the arm 105 can be secured together in any suitable manner as described previously herein, such as with screws as shown in FIGS. 3A, 3B, 5B, and 8B. The blade 103 can be made of any material strong enough to puncture the blister and sharp enough (or capable of being sharpened enough) to cut through the blister, such as described previously herein. In a preferred embodiment, the tang 134 is made from one or more metals, metal alloys, or combination thereof, such as stainless steel.

The arms 104,105 are configured to move within the plane P (defined by the arms 104,105) between the open and closed states. The anvil 102 is configured to move within the plane P between the open and closed states. The cutting edge is positioned within (or extends within) the plane P and is configured to move within the plane P between open and closed states. In some implementations, the anvil and the blade can be offset from the arms (e.g., located below or above the plane of the arms) in which case the anvil and the blade would move parallel to the plane P of the arms. Such configurations and movement enable the anvil 102 and the blade 103 to be placed around the blister 16 and closed to puncture and cut open the blister 16—in a manner that minimally obstructs the user's view of the blister 16 from above, such as can be seen from the top view shown in FIGS. 6A and 6B, which are described later herein.

The base side 125 of the anvil 102, the base side 120 of the blade 103, a base side 137 of the connecting portion 106, and base sides 135,136 of the respective arms 104,105 are flush so as to enable the tool to be placed flat on a level surface (e.g., the flat base 15, the table surface, or both). For example, the base side 125 of the anvil 102 and the base side 120 of the blade 103 (or the base side 125 of the anvil 102, the base side 120 of the blade 103, and the base sides 135,136 of the respective arms 104,105) can be placed flat against the flat base 15 of the blister pill pack 10 with the blister 16 between the anvil 102 and the blade 103. As another example, the user can place the blister pill pack 10 on a table surface, and then place the tool 100 on top of the flat base 15 of the blister pill pack 10 and the table surface since the height of the flat base 15 is minimal or negligible. In addition, such flush configuration can be beneficial to keep the cutting edge 117 parallel to the flat base 15 and in the base region 17 of the blister 16 when puncturing and cutting the blister 16.

The cutting tool 100 includes a locking mechanism that is configured to secure the arms 104,105 in the closed state when the arms 104,105 are closed. The locking mechanism includes locking elements 126a,126b that extend from the arms 104,105, respectively. The locking element 126a is configured as a flat tab with a lip 128a protruding from a flat surface. The locking element 126a extends from the arm 104 towards the arm 105. The locking element 126b is configured as a flat tab with a lip 128b protruding from a flat surface. The locking element 126b extends from the arm 105 towards the arm 104. The locking elements 126a,126b are configured to overlap when the tool 100 is moved from the open state to closed state. The locking elements 126a,126b are configured so the lips 128a,128b slide against and past each other when the tool 100 enters the closed state. As the external force from the user is removed, the resistive force from the connecting portion 106 presses the lips 128a,128b back against each other from the opposite direction than when entering the closed state. The lips 128a,128b are configured with a shape that secures (e.g., hooks) the lips together in one direction to prevent the lips 128a,128b from moving past each other in the opposite direction. With the external force removed, the resistive force continues to press the lips 128a,128b against each other to lock the tool 100 in the closed state. The locking mechanism also includes releasing element 126c that can be triggered by the user to unlock the tool 100. The releasing element 126c extends from the locking element 126b and includes a surface for the user to press against. When the user presses against the surface of the releasing element 126c, the releasing element 126c displaces the locking element 126b and releases (e.g., unhooks) the lips 128a,128b. As a result, the cutting tool 100 is unlocked from the closed state and the resistive force pushes the arms 104,105 back into the biased-open state. The locking mechanism can be beneficial to stabilize the cutting tool 100 in the closed state once the blister is cut open, and can serve as a safety mechanism to keep the cutting edge 117 shielded by the anvil 102 when the cutting tool 100 is not being used.

In another embodiment, the locking elements 126a,126b are configured to overlap each other with a small space between the lips 128a,128b so they do not slide against each other and are unable to secure to each other (e.g., hook) in the closed state. In such case, the arms 104,105 do not lock when the arms 104,105 are closed. Instead, the locking mechanism can be activated by the user when desired. For example, the connecting portion 106 and the arms 104,105 can be made from an elastic material such that the arms 104,105 can bend slightly. When the user wants to activate the locking mechanism, the user can squeeze the handle 101 to close the tool 100 and at the same time press the arms 104,105 in opposite directions (orthogonal to the plane P) so that the lips 128a,128 are brought together and secure (e.g., hook) to each other and lock the tool 100 in the closed state. The user can then remove any external force applied to the handle 101 and the tool 100 will remain in the closed state. The lips 128a,128b are sufficiently secured together to keep the arms 104,105 maintained in their slightly bent position and the tool 100 locked. When the user wants to use the tool 100 again to cut open another blister, the user can press on the releasing element 126c to unlock the arms 104,105 from the closed state. With the lips 128a,128b are no longer secured together, the elastic arms 104,105 return to their unbent position and the lips 128a,128b are again separated with enough space to prevent them from securing together.

The tool 100 includes a limiting mechanism that limits how far the arms 104,105 can be opened in the open state. The limiting mechanism can be beneficial to serve as a safety mechanism to keep the tool 100 from opening too far and dangerously exposing the blade 103. The limiting mechanism includes limiting elements 129a,129b that extend from the arms 104,105, respectively. The limiting element 129a is configured as a flat tab with a lip 131a protruding from a flat surface. The limiting element 129a extends from the arm 104 towards the arm 105. The limiting element 129b is configured as a flat tab with a lip 131b protruding from a flat surface. The limiting element 129b extends from the arm 105 towards the arm 104. The limiting elements 129a,129b overlap one another when the tool 100 is in the open and closed states. The limiting elements 129a,129b are configured so the lips 131a,131b abut each other when the arms 104,105 are opened a threshold distance from one another. The lips 131a,131b are configured with a shape that prevents the lips 131a,131b from moving past each other when abutting.

The limiting mechanism is configured to prevent the arms 104,105 from being opened beyond the limiting distance. The arms 104,105 are biased open at a smaller distance apart than the limiting distance. In such case, the lips 131a,131b are not abutting and the arms 104,105 are able to move. If the arms 104,105 are opened as far as the limiting distance, then the lips 131a,131b abut and prevent the arms 104,105 from opening any farther. In another embodiment, the limiting mechanism 129 can be configured to cooperatively bias the arms 104,105 at the limiting distance. For example, the resistive force from the connecting portion 106 can be configured to open the arms 104,105 until the lips 131a,131b abut each other and maintain the arms 104,105 at the limiting distance.

The limiting elements 129a,129b can be configured to release from each other to allow the arms 104,105 to open beyond the limiting distance, as shown in FIGS. 5A and 5B. For example, the arms 104,105 and the coupling portion 106 can be elastic to allow the user to slightly bend one or both of the arms 104,105 away from each other (e.g., in orthogonal directions to the plane P). When doing so, the limiting elements 131a,131 are moved away from each other (e.g., in orthogonal directions to the plane P) and prevented from abutting (e.g., hooking) to enable the arms 104,105 to open beyond the limiting distance.

The locking mechanism (e.g., the locking elements 126a,126b and the releasing element 126c) and limiting mechanism (e.g., the limiting elements 129a,129b) can be made from any suitable material, such as described previously herein. In a preferred embodiment, the locking mechanism, the limiting mechanism, the arms 104,105, the coupling portion 106, and the anvil 102 are integrated or made from a unitary piece of polymeric material, such as a thermoplastic elastomer (TPE) or acrylonitrile butadiene styrene (ABS).

In use, the user holds the handle 101 of the cutting tool 100 with one hand and can hold the blister pill pack 10 in the other hand, or place the blister pill pack 10 on a surface such as a table. If the tool 100 is locked in the closed state, then the user can press on the releasing element 126c to unlock the arms 104,105 from the closed state. The user can press the releasing element 126c using the same hand holding the tool 100, such as with her thumb, or can use the other hand if desired. When the user presses against the surface of the releasing element 126c, the releasing element 126c displaces the locking element 126b to unhook or release the lips 128a,128b. As a result, the cutting tool 100 is unlocked from the closed state and the resistive force pushes the arms 104,105 into the biased open state.

While the arms 104,105 are in the open state, the user positions the base sides 125,120 of the respective anvil 102 and blade 103 flat against the flat base 15 of the blister pill pack 10. The user can then move the anvil 102 and the blade 103 around the blister 16 so that the blister 16 is positioned between the surface 115 of the anvil 102 and the cutting edge 117 of the blade, preferably with the edge point 122 positioned in the approximate middle of the side of the blister 16. In the process, one or both of the anvil 102 and the blade 103 may be inserted between rows or columns depending on the particular location of the blister selected. In some instances, the user can push the tool 100 towards the blister 16 until the blister 16 abuts the stop element 127 with the edge point 122 positioned on the side of the blister 16. In some instances, such as with small blisters, the stop element 127 may not be used and the user can visually position the edge point 122 in the approximate middle of the side of the blister 16.

If the spatial separation between the anvil 102 and the blade 103 in the biased-open state is significantly more than the width of the blister, then the user can squeeze the grip guides 111,112 to apply just enough external force to the arms 104,105 to reduce the spatial separation to an optimal size to position the anvil 102 and the blade 103 around the blister. If the spatial separation between the anvil 102 and the blade 103 in the biased-open state is less than the width of the blister, then the user can position the anvil 102 and the blade 103 against the blister 16 so that one corner 140 of the blister 16 is abutting inside of the distal end 133 of the anvil 102, and the other corner 141 of the blister is abutting the distal edge portion 123 of the blade 103 (or the blunted distal end 118). Next, the user can push the tool 100 towards the blister 16. The pressure from the corners 140,141 of the blister 16 against the distal edge portion 123 and the distal end 133 pushes the anvil 102 and the blade 103 open wider as they slide along the sides of the blister 16 until the blister 16 abuts the stop element 127 and the edge point 122 positioned to one side of the blister 16, preferably in the approximate middle of the side of the blister 16. In some instances, such as with small blisters, the stop element 127 may not be used and the user can visually position the edge point 122 in the approximate middle of the side of the blister.

As shown in FIG. 6A, the tool 100 is in the open state with the blister 16 positioned between the anvil 102 and the blade 103. The hand of the user is not shown in FIG. 6A to provide an unobstructed view of the tool 100. In the example shown in FIG. 6A, both the anvil 102 and the blade 103 are inserted between rows on the blister pill pack 10. The user can continue to move the anvil 102 and the blade 103 farther between the rows and along the sides of the blister 16 until the blister 16 eventually abuts the inner surface 115 of the stop element 127. The stop element 127 stops the blister 16 in the appropriate position to open the blister 16. As can be seen in FIG. 6A, the user's view of the space between the anvil 102 and the blade 103 is unobstructed by the cutting tool 100, making it easy for the user to position the anvil 102 and the blade 103 around the blister 16. Since the user's hand is around the handle 101, the user's hand does not obstruct the view of the anvil 102 and the blade 103 either.

Once the blister 16 is in the appropriate position, the user can apply external force to the grip guides 111,112 of the arms 104,105 (e.g., squeeze the grip guides) with the corresponding fingers of one hand to move the arms 104,105 into the closed state. As the external force is applied, the anvil 102 is pressed against the blister 16, which stabilizes the blister 16 as the edge point 122 punctures the blister. The edge point 122 punctures the base region 17 of the cavity-forming protrusion 13 of the blister 16, and then the distal and proximal edge portions 123,124 of the cutting edge 117 further cut open the base region 17 from the point of puncture. The cutting edge 117 of the blade 103 is advanced between the pills 14 and the flat base 15 of the blister pill pack 10. By entering the base region 17 of the cavity-forming protrusion 13 of the blister 16, the edge point 122 punctures and is advanced between the flat base 15 and the pills 14. The flat base side 120 of the blade 103, and the angle of the bevel 138 down to the base side 120, can facilitate the puncturing of the blister 16 in the base region 17 close to the flat base 15 of the blister pill pack 10. This can ensure entry between the flat base 15 and the pills 14. Furthermore, the bevel 138 on the beveled side 121 of the blade 103 can push the pill upward (or away from the flat base 15) to facilitate the positioning of the blade 103 between the flat base 15 and the pills 14. In this way, damage to the pills and interference by the pills are minimized while the blade 103 is cutting open the blister 16.

When sufficient external force is applied, the cutting edge 117 is advanced until the edge point 122 is abutting the anvil 102 and positioned in the recessed area 116. In an embodiment, the anvil 102 is made from an elastic material that can cause the anvil 102 to slightly deform after contact with the blade 103, such as when too much external force is applied. In such case, once the edge point 122 enters the recessed area 116, the excess external force causes the recessed area 116 to deform, enabling the distal edge portion 123 to enter the recessed area 116, as shown in FIGS. 8A and 8B.

The arms 104,105 are moved into the closed state when the user has applied sufficient external force to the arms 104,105 to bring the tool 100 into the closed state with the anvil 102 and the blade 103 adjacent to each other. As can be seen in FIGS. 6A and 6B, the user's view the anvil 102, the blade 103, and the opened blister 16 is unobstructed by the cutting tool 100 during the entire operation to open the blister 16.

In one embodiment, as the arms 104,105 are moved into the closed state, the locking elements 126a,126b overlap each other and the lips 128a,128b slide against and past each other to lock the tool 100 in the closed state. As the external force from the user is removed, the resistive force from the connecting portion 106 presses the lips 128a,128b back against each other from the opposite direction than when entering the closed state. The lips 128a,128b are configured with a shape that secures (e.g., hooks) the lips together in one direction to prevent the lips 128a,128b from moving back past each other in the opposite direction. With the external force removed, the resistive force continues to press the lips 128a,128b back against each other to lock the tool 100 in the closed state.

In another embodiment, the locking elements 126a,126b are configured to overlap each other with a small space between the lips 128a,128b so they do not slide against each other and are unable to secure to each other (e.g., hook) in the closed state. In such case, the arms 104,105 do not lock when the arms 104,105 are closed. Instead, the locking mechanism can be activated by the user when desired. For example, the connecting portion 106 and the arms 104,105 can be made from an elastic material such that the arms 104,105 can bend slightly. When the user wants to activate the locking mechanism, the user can squeeze the handle 101 to close the tool 100 and at the same time press the arms 104,105 in opposite directions (orthogonal to the plane P) so that the lips 128a,128 are brought together and secure (e.g., hook) to each other and lock the tool 100 in the closed state. The user can then remove any external force applied to the handle 101 and the tool 100 will remain in the closed state. The lips 128a,128b are sufficiently secured together to keep the arms 104,105 maintained in their slightly bent position. When the user wants to use the tool 100 again to cut open another blister, the user can press on the releasing element 126c to unlock the arms 104,105 from the closed state. With the lips 128a,128b no longer secured together, the elastic arms 104,105 return to their unbent position and the lips 128a,128b are again separated with enough space to prevent them from securing together.

In an embodiment, the cutting edge 117 is configured to not cut entirely through the cavity-forming protrusion 13 of the blister 16. For example, in the closed state, the edge point 122 can be configured to enter the recessed area 116 and abut the anvil 101, while the distal and proximal edge portions 123,124 are configured to stop next to the anvil 102 but not abut the anvil 102. As a result, the distal and proximal edge portions 123,124 do not cut all the way through the cavity-forming protrusion 13 of the blister 16. As a result, the pills 14 can be retained in the blister 16 and not fall out when the blister 16 is cut open. To access the pills 14, the user can then lift the cavity-forming protrusion 13. Moreover, since the tool 100 closes with the uncut portion of the cavity-forming protrusion 13 secured between the anvil 102 and the blade 103, the user can use one hand to hold the tool 100, which holds the blister pill pack 10, while the other hand lifts the cavity-forming protrusion 13 to access the pills 14.

In another embodiment, the cutting edge 117 is configured to cut all the way through the cavity-forming protrusion 13. For example, in the closed state, the edge point 122 can enter the recessed area 116 and abut the anvil 101, and the distal and proximal edge portions 123,124 can also abut the anvil 102. For example, the recessed area 116 can be shaped to receive the edge point 122, while the anvil 102 is shaped so that the entire distal and proximal edge portions 123,124 abut the surface 115 of the anvil 102. In some implementations, the recessed area 116 can be shaped to receive the edge point 122 and some or all of the distal and proximal edge portions 123,124 sufficient to cut through the entire blister. When the cavity-forming protrusion 13 is cut all the way through, the pills 14 can remain in the detached blister 16 as the blister 16 sits on the blade 103 of the tool 100. The user can then grab both the detached cavity-forming protrusion 13 and the pills 14a,15b, or lift the cavity-forming protrusion 13, to access the pills 14. Alternatively, if the blister pill pack 10 was positioned on the table surface, the user can remove the blade 103 from under the detached cavity-forming protrusion 13 and the pills 14. In this way, blister 16 can rest on the blister pill pack 10 until the user lifts the cavity-forming protrusion 13 to access the pills 14.

When the tool 100 enters the closed state, the cutting edge 117 of the blade 103 remains shielded by the anvil 102. This allows the user to handle the tool 100 in a safe manner that does not expose the cutting edge 117. The user can then store the tool 100 as it is locked and ready for storage. When the user wants to use the tool 100 again to cut open another blister, the user can press on the releasing element 126c to unlock the arms 104,105 from the closed state, as previously performed for the blister 16.

In some instances, such as with large blisters, the user may be required to open the arms 104,105 beyond the limiting distance in order to position the anvil 102 and the blade 103 around a blister. In such case, the user can slightly bend one or both of the arms 104,105 away from each other in orthogonal directions to the plane P defined by the arms 104,105. When doing so, the limiting elements 129a,129b are also moved away from each other in orthogonal directions to the plane P, which releases or unhooks the lips 131a,131b to enable the arms 104,105 to open beyond the limiting distance. The user can then position the anvil 102 and the blade 103 around the blister until the blister is abutting the stop element 127 or until the edge point 122 is in the approximate middle of the side of the blister. As described above, the user can apply external force to the arms 104,105 to move the arms 104,105 into the closed state. As the arms 104,105 move from the open state to the closed state, the limiting elements 129a,129b return back to being overlapped and the lips 131a,131b positioned to prevent movement beyond the limiting distance.

Throughout the foregoing description, and for the purposes of explanation, numerous specific details are set forth in order to provide a thorough understanding of the described techniques. It will be apparent, however, to one skilled in the art that these techniques can be practiced without some of these specific details. Although various embodiments that incorporate these teachings have been shown and described in detail, those skilled in the art could readily devise many other varied embodiments or mechanisms to incorporate these techniques. Also, embodiments can include various operations as set forth above, fewer operations, or more operations, or operations in another order. Accordingly, the scope and spirit of the invention should only be judged in terms of any accompanying claims that may be appended, as well as any legal equivalents thereof.

Reference throughout the specification to “one embodiment” or “an embodiment” is used to mean that a particular feature, structure or characteristic described in connection with an embodiment is included in at least one embodiment. Thus, the appearance of the expressions “in one embodiment” or “in an embodiment” in various places throughout the specification are not necessarily referring to the same embodiment. Further, the particular features, structures or characteristics may be combined in any suitable manner in one or several embodiments. Although the present invention has been described above with reference to specific embodiments, it is not intended to be limited to the specific form set forth herein. Rather, embodiments other than those specific described above are equally possible within the scope of any accompanying claims. Moreover, it should be appreciated that the terms “comprise/comprises” or “include/includes”, as used herein, do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality. Finally, reference signs in the claims are provided merely as a clarifying example and should not be construed as limiting the scope of the claims in any way.

What is claimed is:

1. A hand-held cutting tool for opening a blister of a blister pill pack to enable user access to one or more pills inside the blister, the hand-held cutting tool comprising:
a handle comprising:
a first arm having a first proximal end and a first distal end;
a second arm having a second proximal end and a second distal end; and
a connecting portion extending from the first and second proximal ends of the respective first and second arms, wherein the first and second arms extend from the connecting portion to the respective first and second distal ends, and wherein the connecting portion is configured to maintain spatial separation between the first and second proximal ends;
an anvil extending from the first distal end of the first arm; and
a blade extending from the second distal end of the second arm, the blade comprising a cutting edge facing the anvil;
wherein the first and second arms are configured to move between:
a closed state comprising:
the first and second distal ends moved all the way towards each other; and
the cutting edge facing, and adjacent to, the anvil; and
an open state comprising:
the first and second distal ends moved out of the closed state; and
the cutting edge facing, and spatially separated from, the anvil; and
wherein, when the first and second arms are moved from the open state with the blister positioned between the anvil and the cutting edge to the closed state, the cutting edge is configured to puncture and cut the blister open to enable user access to one or more pills inside the blister.

2. The hand-held cutting tool of claim 1, wherein the cutting edge comprises an edge point configured to puncture the blister when the first and second arms are moved from the open state with the blister positioned between the anvil and the cutting edge to the closed state.

3. The hand-held cutting tool of claim 2, wherein the cutting edge further comprises:
a proximal edge portion; and
a distal edge portion;
wherein the edge point extends from the proximal and distal edge portions such that the edge point is closer to the anvil than the proximal and distal edge portions when the first and second arms are in the open state;
wherein the edge point is located between the proximal and distal edge portions, the distal edge portion extending from the edge point towards a third distal end of the blade, and the proximal edge portion extending from the edge point towards the second arm; and
wherein, when the first and second arms are moved from the open state with the blister positioned between the anvil and the cutting edge to the closed state, the cutting edge is configured to puncture the blister with the edge point and then cut the blister with the proximal and distal edge portions.

4. The hand-held cutting tool of claim 3, wherein the distal and proximal edge portions extend linearly away from the edge point such that distances from the distal and proximal edge portions to the anvil linearly increase away from the edge point.

5. The hand-held cutting tool of claim 4, wherein the blade further comprises:
a first base side that is flat; and
a beveled side opposite the first base side, wherein the bevel side comprises a bevel that angles down to the first base side to form the cutting edge.

6. The hand-held cutting tool of claim 5, wherein the third distal end of the blade is blunted.

7. The hand-held cutting tool of claim 6, wherein the anvil comprises a second base side that is flat;
wherein the first base side of the blade is flush with the second base side of the anvil when the first and second arms are in the closed state;
wherein, when the first and second arms are moved from the open state with the blister positioned between the anvil and the cutting edge, the first base side of the blade and the second base side of the anvil are configured to be placed flat against a flat base of the blister pill package;
wherein, when the first and second arms are moved from the open state with the blister positioned between the anvil and the cutting edge to the closed state, the cutting edge is configured to puncture and cut the blister open in a base region of the blister such that the cutting edge is advanced between the one or more pills and the flat base; and
wherein the blister extends from the flat base of the blister pill pack and the base region is next to the flat base.

8. The hand-held cutting tool of claim 7, wherein the anvil further comprises a first surface facing the cutting edge;
wherein the first surface is curved and has a concavity facing the cutting edge of the blade;
wherein, when the first and second arms are in the closed state, an entire length of the cutting edge is adjacent to the anvil such that the cutting edge is shielded by the anvil;
wherein the second base side of the anvil comprises a recessed area configured to receive the edge point of the blade when the first and second arms are in the closed state; and
wherein the anvil further comprises a stop element extending toward the second arm, the stop element configured to abut and stop the blister when the blister is inserted between the anvil and the blade.

9. The hand-held cutting tool of claim 8, wherein the first and second arms are configured to move between the open and closed states within a plane defined by the first and second arms;
wherein the blade and the anvil are positioned, and configured to move, within or parallel to the plane when the first and second arms are moved between the open and closed states; and
wherein, when the first and second arms are moved from the open state with the blister positioned between the anvil and the cutting edge to the closed state, the plane is parallel to the flat base of the blister pill package.

10. The hand-held cutting tool of claim 9, wherein the first arm comprises a third base side;
wherein the second arm comprises a fourth base side;
wherein the connecting portion comprises a fifth base side;
wherein the first, second, third, fourth, and fifth base sides are configured to be flat and flush to each other so as to enable the tool to be placed flat on a level surface;
wherein the first and second arms are elastically biased in a biased-open state;
wherein an external force is required to be applied to the first and second arms to move the first and second arms from the biased-open state to the closed state;
wherein the first arm, the second arm, and the connecting portion is made from unitary piece of elastic material;
wherein the connecting element comprises a curve-shaped member; and
wherein the first and second arms extend from different ends of the curved-shaped member.

11. The hand-held cutting tool of claim 10, further comprising:
a locking mechanism configured to lock the first and second arms in the closed state when the first and second arms enters the closed state;
wherein the locking mechanism comprises:
a first locking element extending from the first arm;
a second locking element extending from the second arm, wherein the first and second locking elements are configured to releasably secure to each other to lock the first and second arms are in the closed state; and
a releasing element configured to release the first and second locking elements from being secured to each other when triggered by the user; and
a limiting mechanism configured to stop the first and second arms from opening beyond a limiting distance;
wherein the limiting mechanism comprises:
a first limiting element extending from the first arm; and
a second limiting element extending from the second arm; and
wherein the first and second limiting elements are configured to releasably secure to each other to stop the first and second arms from opening beyond a limiting distance.

12. The hand-held cutting tool of claim 3, wherein at least one of the distal and the proximal edge portions is curved and extend away from the edge point with a concavity of the curve facing the anvil.

13. The hand-held cutting tool of claim 1, wherein the blade further comprises:
a first base side that is flat; and
a beveled side opposite the first base side, wherein the bevel side comprises a bevel that angles down to the first base side to form the cutting edge.

14. The hand-held cutting tool of claim 13, wherein the anvil comprises a second base side that is flat;
wherein the first base side of the blade is flush with the second base side of the anvil when the first and second arms are in the closed state;
wherein, when the first and second arms are moved from the open state with the blister positioned between the anvil and the cutting edge, the first base side of the blade and the second base side of the anvil are configured to be placed flat against a flat base of the blister pill package;
wherein, when the first and second arms are moved from the open state with the blister positioned between the anvil and the cutting edge to the closed state, the cutting edge is configured to puncture and cut the blister open in a base region of the blister such that the cutting edge is advanced between the one or more pills and the flat base; and
wherein the blister extends from the flat base of the blister pill pack and the base region is next to the flat base.

15. The hand-held cutting tool of claim 1, wherein the anvil comprises a first surface facing the cutting edge;
wherein the first surface is curved and has a concavity facing the cutting edge of the blade;
wherein, when the first and second arms are in the closed state, an entire length of the cutting edge is adjacent to the anvil such that the cutting edge is shielded by the anvil;
wherein the anvil further comprises a stop element extending toward the second arm, the stop element configured to abut and stop the blister when the blister is inserted between the anvil and the blade; and
wherein the anvil comprises a recessed area configured to receive the edge point of the blade when the first and second arms are in the closed state.

16. The hand-held cutting tool of claim 1, wherein a distal end of the blade is blunted, and wherein the distal end is distal to the second arm.

17. The hand-held cutting tool of claim 1, wherein the first and second arms are configured to move between the open and closed states within a plane defined by the first and second arms;
wherein the blade and the anvil are positioned, and configured to move, within or parallel to the plane when the first and second arms are moved between the open and closed states; and
wherein, when the first and second arms are moved from the open state with the blister positioned between the anvil and the cutting edge to the closed state, the plane is parallel to the flat base of the blister pill package.

18. The hand-held cutting tool of claim 1, wherein the blade comprises a first base side;
wherein the anvil comprises a second base side;
wherein the first arm comprises a third base side;
wherein the second arm comprises a fourth base side;
wherein the connecting portion comprises a fifth base side; and
wherein the first, second, third, fourth, and fifth base sides are configured to be flat and flush to each other so as to enable the tool to be placed flat on a level surface.

19. The hand-held cutting tool of claim 1, wherein the first and second arms are elastically biased in a biased-open state;
wherein an external force is required to be applied to the first and second arms to move the first and second arms from the biased-open state to the closed state;
wherein the first arm, the second arm, and the connecting portion is made from unitary piece of elastic material;
wherein the connecting element comprises a curve-shaped member;
wherein the first and second arms extend from different ends of the curved-shaped member;
wherein the first and second arms comprise first and second grip guides, respectively, for guiding a user as to where to apply the external force;
wherein the first and second grip guides are located next to the anvil and the blade, respectively; and
wherein the first and second grip guides comprise an enlarged area on the respective first and second arms configured for the user to apply the external force.

20. The hand-held cutting tool of claim 1, further comprising:
a locking mechanism configured to lock the first and second arms in the closed state when the first and second arms enters the closed state;
wherein the locking mechanism comprises:
a first locking element extending from the first arm; and
a second locking element extending from the second arm; and
wherein the first and second locking elements are configured to releasably secure to each other to lock the first and second arms are in the closed state;
a releasing element configured to release the first and second locking elements from being secured to each other when triggered by the user; and
a limiting mechanism configured to stop the first and second arms from opening beyond a limiting distance;
wherein the limiting mechanism comprises:
a first limiting element extending from the first arm; and
a second limiting element extending from the second arm; and
wherein the first and second limiting elements are configured to releasably secure to each other to stop the first and second arms from opening beyond a limiting distance.
